(19) United States
(12) Patent Application Publication
(10) Pub. No.: US 2013/0013414 A1
(43) Pub. Date: Jan. 10, 2013

(54) APPARATUS AND METHOD FOR DIRECT DISCOVERY OF DIGITAL CONTENT FROM OBSERVED PHYSICAL MEDIA

(76) Inventor: Maurice HAFF, Daytona Beach, FL (US)

(21) Appl. No.: 13/533,495

(22) Filed: Jun. 26, 2012

Related U.S. Application Data
(60) Provisional application No. 61/504,361, filed on Jul. 5, 2011.
(60) Provisional application No. 61/539,233, filed on Sep. 26, 2011.

(51) Int. Cl. G06Q 30/02

(52) U.S. Cl. 705/14.64

(57) ABSTRACT

The invention provides apparatus and associated method(s) for interrelating digital content stored on Internet websites to physical form media such as that used in out-of-home (e.g., outdoor) advertising. The invention provides apparatus for use in a communications network adapted to provide registered images of physical form media to a plurality of mobile devices connectable to the communication network, comprising: an interface for registering on a registrar device digital images of physical form media, a receiver for receiving at the registrar device geospatial coordinates of a mobile device, a transmitter for transmitting to the mobile device from the registrar device registered digital images of physical form media observable at the received geospatial coordinates, an input for including hyperlinks in registered digital images enabling access to digital content related to physical form media, the digital content being accessible to the mobile device on storage servers connected to the communications network.

### CROSS REFERENCES TO RELATED APPLICATIONS

This application claims the benefit of U.S. provisional application Ser. No. 61/504,361 filed on Jul. 5, 2011 and U.S. provisional application Ser. No. 61/539,233 filed on Sep. 26, 2011 in the name of Maurice Haff, which are expressly incorporated herein by reference each in its entirety.

### BACKGROUND OF THE INVENTION

1. Field of the Invention

The present invention is related to physical form media used in advertising. More particularly, the present invention is directed to an apparatus and associated method(s) for interrelating digital content stored on Internet websites to physical form media such as that used in out-of-home (e.g., outdoor) advertising.

2. Background of the Invention and Related Art

Physical representations of advertising information appear in many forms in a variety of media, such as billboards, posters, signs, bus stop shelters, highway logo signage, corporate names and logos on buildings, and public graffiti. Such representations are geographically distributed, relatively abbreviated by design in textual content, and geared towards communicating a message to a public that is not actively searching for a particular business, product, event, or service. With the exception of digital renditions, information presented in such physical forms is relatively static over time in the near to medium term. Transient character of such information may vary from months in the case of billboards down to hours in the case of graffiti. The transient display in digital renditions may be visible for as little as 8 seconds and then repeated in another time interval. Presented information may or may not include sufficient detail to enable user action relative to the information offered. When contact information is provided, it is typically in the form of a name, physical address, telephone number, and/or web Uniform Resource Locator (URL). Action required to obtain additional related information is at best indirect. Depending on the relative motion and speed of the observer to the information presented in physical form media, details required for action may be missed altogether.

Out-of-home (used interchangeably with outdoor) advertising is essentially any type of advertising that reaches the consumer while he or she is outside the home. This is in contrast with broadcast, print, and Internet advertising. Out of home advertising, therefore, is focused on marketing to consumers when they are “on the go” in public places, in transit, waiting (such as in a medical office), and/or in specific commercial locations (such as in a retail venue). Outdoor advertising formats fall into four main categories: billboards, street furniture, transit, and alternative. Digital billboards represent a new, rapidly emerging category. Digital billboards typically display static messages that resemble standard printed billboards when viewed, but also allow advertisers to change messages throughout the course of a day. Some digital billboards can provide dynamic visual displays including full motion video and audio.

Traditional roadside billboards remain the predominant form of outdoor advertising in the US with 66 percent of total annual revenue. Today, billboard revenue is 73 percent local ads, 18 percent national ads, and 9 percent public service ads. Street furniture is made up of formats such as bus shelters, news racks, mall kiosks, and telephone booth advertising. This form of outdoor advertising is mainly seen in urban centers. Additionally, this form of advertising provides benefits to communities, as street furniture companies are often responsible for building and maintaining the shelters people use while waiting for a bus. Transit advertising is typically advertising placed on anything which moves, such as buses, subway advertising, truck sides, and taxis, but also includes fixed static and electronic advertising at train and bus stations and platforms. Airport advertising, which helps businesses address an audience while traveling, is also included in this category. Municipalities often accept this form of advertising, as it provides revenue to city and port authorities. Highway logo signs are most frequently used near exit ramps on Interstate highways. These types of signs notify a driver of the presence of a business by using a related logo. Usually distance and direction from an exit is provided on a second sign near the end of an off-ramp. Finally, alternative advertising includes ads in stadiums, on gas pumps, bike racks, rest areas, and other non-traditional formats. Alternative advertising provides a way to address consumers in places they may not expect.

Street furniture, transit, and alternative media formats comprise 34 percent of total outdoor revenue in the US. Some of these formats have a higher percentage of national ads than traditional billboards. The outdoor industry includes more than 2,100 operators in 50 states representing the four major outdoor format categories. These outdoor media companies range from public, multinational media corporations to small, independent, family-owned businesses. Lamar Advertising Company and Clear Channel Outdoor are the largest U.S. operators, each with nearly 1,000,000 out-of-home displays.

According to the Outdoor Advertising Association of America, Inc. (OAAA), businesses expended $5.8 billion dollars on outdoor advertising in 2004, and increased the amount spent to nearly $7 billion in 2008. In part, the OAAA attributes continuing success of outdoor advertising to the fact that while diversified forms of media have splintered audiences of traditional venues like newsprint and radio, automobile traffic continues to grow. Tens of millions of Americans commute each day, by some estimates covering over three trillion miles annually. Strategically placed outdoor advertising can guarantee substantial exposure for very little investment, comparatively speaking. However, outdoor advertising lacks the richness of detail and flexibility of digital form media typically presented on Internet web sites. Attempts to provide a more rich information experience for an observer of physical form media is generally limited and may include providing expanded text, listing a URL for a web site providing product or service information, dynamic digital display billboards, and in a few instances the radio frequency for an informational radio station (e.g., ads for the City of Branson, Mo.).

Recent efforts to better manage out-of-home advertising media include the International Billboard Identity (IBI) project that provides a unique machine-readable identification number, which marks any Indoor/Outdoor Advertisements unmistakably. The number has been in use extensively by the international billboard-trade. Currently, 275 countries and territories are IBI Coded countries, and 36,606 cities are IBI Coded cities. There are 25 IBI Coded types of indoor & outdoor ads. The IBI number consists of four segments: Type identifier, Country identifier, City identifier, Digit identifier.

Another example of efforts to reach customers when they may not be searching for a particular business, product, event, or service is the online business concept of affiliate marketing used on the Internet. This concept has significantly impacted the way large corporations, small businesses and companies do business. Affiliate marketing is a marketing practice in which a business rewards one or more affiliates for each visitor or customer sent to the business web site and brought about by the affiliate's own marketing efforts. A Simple, Direct URL Link is the most basic and most limited form of referral tracking technology. The affiliate ID is visible to the customer in the URL with this method, because it passes the referring affiliate's ID directly to the URL of a specific page. Cookie Tracking is the most popular method to track web visitors “from click through to conversion”, because it is simple to implement and use, requires no significant web design considerations, and rarely does it impact the performance of the web server. With this method a 3rd-party affiliate software program can be installed as a stand-alone product requiring minimal changes to an existing web site. However, affiliate marketing—using one website to drive traffic to another—is a form of online marketing, which is frequently overlooked by advertisers and carries a much lower profile than other forms of marketing.

Affiliates place the merchant's affiliate links on their web site. The affiliate link defines the Affiliate ID within the link. The web visitor clicks the link and is sent to the affiliate tracking software. The affiliate tracking software plants a small text file or “cookie” on the web visitor's browser. This cookie stores the Affiliate ID. It may also store other information such as the date/time for purposes of tracking how much time elapsed between the click and the conversion. It may also track the specific banner or link that the web visitor clicked. The cookie is also assigned a date as to when it should expire and get deleted. After planting the cookie, the web visitor is then redirected to the page that was defined for the specific banner or link that was clicked. It could be the homepage of the merchant's web site, or a specific product or information page.

Physical representations of information are dynamically encountered by observers in various ways including riding in a moving vehicle such as an automobile or bus, and during personal mobility walking, running, or riding a bicycle. Observations made from moving vehicles often lack adequate time for the observer to recognize enough information to support observer action. Contact information such as a name, telephone number or web address (URL) may not be recalled correctly. The same is true for location information, often limited to highway exit number, route number, and distance or direction from an exit. Even if an observation is made during slower personal mobility, the abbreviated nature of the information provided, or the contact addressing given, may lack specificity or require the observer to take a series of multi-step actions to acquire additional information. Such actions may include using a mobile communication device (e. Android, BlackBerry Storm, iPhone) to dial a telephone number to request information or listen to a recorded message, login to an Internet service provider and enter a URL, conduct a keyword search using a search engine, take a photograph and rely on image recognition, or scan a 2D bar code (a.k.a. QR code) to link to a web site.

Calling a service such as the General Motors Corp. (GM) OnStar service is an example of a telephone search to obtain information about a business. A user can call and verbally ask the attendant for information and directions. Currently, the OnStar service relies on CDMA mobile phone voice and data communication, primarily via Verizon Wireless in the United States and Bell Mobility in Canada, as well as location information using GPS technology. Drivers and passengers can use its audio interface to contact OnStar representatives for emergency services, vehicle diagnostics and directions. GM is currently deploying OnStar Generation 9 hardware that includes enhanced services and diagnostics and the ability to use the mobile application, RemoteLink, which allows a subscriber to perform many functions without the need for calling into the OnStar centre. Functions include remote start, remote lock and unlock, flashing lights and horn as well as viewing up-to-date diagnostics data from the subscriber's iPhone or Android-powered mobile phone. OnStar hardware is currently only manufactured by LG Electronics as of 2011, and includes OEM equipment integrated in to production vehicles and an aftermarket version. The aftermarket version is an interior rear-view mirror with a built-in OnStar module, branded as OnStar FMV. This product became available to the public on Jul. 24, 2011. It provides some of the features an OEM system has, such as Automatic Crash Response, Stolen Vehicle Tracking, Turn-by-Turn Navigation, and Roadside Assistance. OnStar FMV and its embedded Bluetooth® technology allows control of calling functions on a smart phone. Pairing a Bluetooth-compatible phone with the FMV product and use of FMV voice-recognition enables access a contact list and initiation of calls without physical interaction with the phone. OnStar FMV allows pairing of up to five Bluetooth-capable cell phones. GM has announced that during the summer in 2012, the Application Programming Interface (API) for the OnStar system will be opened for use by third party developers. Applications (Apps) developed for use on mobile devices and smartphones will be able to access and use services provided through the OnStar system. Other automobile manufacturers offer similar systems and services, such as SYNC available from Ford Motor Company.

Scanning a 2D bar code displayed on a physical medium can enable access to information embedded in the code or at a web site address linked to the code. However, this works only if the observer is in very close proximity to the physical form media, and not in a moving automobile. Of course, after observing physical form media, information regarding a business can be obtained using a search engine such as Google offered by Google Inc. Google Places is designed to use the Google search engine to help people find businesses. Google Places offers business information organized by category. Search results present the location of businesses on a map as “pins” with alphabetical letters that correspond to a text description displayed as a result of a search. “Clicking” on a pin typically displays a photograph and textual information. The pins on a Google Map are linked to web pages of businesses that have elected to claim their place pin from Google. A user must be searching for a category of business with the Google search engine in order to obtain search results that include Google Places and a map that displays place pins. Google Goggles is a downloadable image recognition application created by Google Inc. which can be currently found on the Mobile Apps page of Google Mobile. It is used for searches based on pictures taken by handheld devices. For example, taking a picture of a famous landmark would search for information about it, or taking a picture of a product's barcode will search for information on the product. As of April 2012, Google Goggles is running on version 1.8.1: it can analyze a picture taken by the phone camera and return results, scan QR codes using Goggles to extract information, recognize famous landmarks, translate by taking a picture of foreign language text, add Contacts by scanning business cards or QR codes, scan text using Optical Character Recognition (OCR), recognize paintings, books, dvd, cds, and most 2D images, Goggles is specifically developed to run on mobile devices running the Android operating system. Goggles runs on any phone running Android version 1.6 or higher and can be installed using the Android Market. Although developed for Android there is also an iPhone version, as part of the Google Search app, available from the iTunes Store or App Store. Goggles requires iPhone 3GS or iPhone 4 on iOS 4.0 or higher to run. On photo sharing Web sites like Flickr, users can tag their photos with information about who or what is in the photo and where is was taken (e.g., “San Francisco” or “Ames, Iowa”). Other users can search or browse by tags to find the most relevant content, including specific location if the tags include geospatial coordinates (i.e., geotagged photos). Geotagging is a process, which is used to embed geographical data, usually longitude/latitude/altitude/geonames (place names) and other geographical data within the metadata into photographs, videos and other types of media formats. Digital photos can include EXIF (Exchangeable Image File Format) headers that provide a way of stamping photos with data that can be read by other applications such as Flickr. There are a variety of cameras and cell phones (a.k.a., smartphones) that include GPS (Global Positioning System) receivers and have the capability to tag photos with geospatial coordinates. EXIF editing software can also be used to enter the GPS information into the EXIF header of digital photos.

The forgoing methods do not address the problem of directly providing expanded information content related to outdoor advertising media. These methods are “search” based and do not address the problem of reaching and communicating a message to a public that is not actively searching for a particular business, product, event, or service.

Some information presented in physical form is not only abbreviated in content, but often highly transient. The new digital billboards typically present each of several display images for only 8 to 10 seconds, which combined with relative motion at highway speeds may not allow sufficient time for an observer to note actionable information. Examples of less high tech transient information presentations are the hand-written chalk messages typically found on sidewalks on college campuses nationwide. Messages for nearly every type of social activity can be found scrolled across the sidewalks inviting participation in political elections, benefit marathons, club meetings, music events, and so forth. Generally, only minimal information content can be included in such messages due to space, time, and even weather limitations. Usually a telephone number, social network address, or meeting/event time and place are provided.

In the related art, to find and obtain virtual information related to physical form information, an observer is required to take actions such as making telephone calls, listening to pre-recorded messages, entering web addresses, conducting web searches, referencing map displays, or taking pictures. Currently, location based services typically provide category topics for a variety of establishments, such as restaurants, fueling stations, and specialty stores. When a search category is selected, a listing of such establishments is provided in a relatively broad geographic area surrounding a current location of a mobile device. Listed names may or may not be linked to a web site URL. There is no interrelation made between digital content and a specifically observed physical form medium as in the present invention. Compared to search based methods, by directly interrelating digital content with specifically observed physical form media the observer receives relevant content faster and with fewer intermediate actions. The advertiser reaches the observer directly with the specific content intended for the medium, with no competing “hits” as would be delivered from a search engine.

In the related art, search engine information retrieval and access methods generally use text based category (e.g. restaurant) and keyword (e.g., Italian) search. Google search uses text and keywords to search indexes of web pages and delivers the search results based on a page ranking scheme (http://www.google.com/howgoogleworks/). Semantic search seeks to improve search accuracy by understanding searcher intent and the contextual meaning of terms as they appear in the searchable dataspace, whether on the Web or within a closed system, to generate more relevant results (see en.wikipedia.org/wiki/Semantic search). These approaches do not correlate a user's immediate experiences in a physical setting with an information rich experience in a virtual environment. There is no direct and immediate correlation between searchable information on the web with the user's physical observations.

Advertisers are increasingly interested in “engaging” consumers in interaction with advertising media. One of the latest offerings uses image recognition technology to recognize an image of an advertising medium in a picture taken using a “smart phone” and to correlate the image in the picture with product information. For example, JCDecaux, located in France, announced an iPhone application called “U snap” on Oct. 7, 2010: when a consumer sees a poster (paper or digital) and takes a photo of it on the phone, the application running on the iPhone recognizes it using image recognition technology, provides product information and discount vouchers and directions to the nearest retailer. The JCDecaux application was developed by a company called Telequid. This approach suffers from at least the limitation that the relative motion of the observer to the physical media must be such that a photograph of the image presented on a medium can be acquired with some clarity. Riding in or operating an automobile is likely to prevent that, as would poor weather conditions or absence of proximate access to the medium.

There are emerging technologies directed to presenting advertising messages on digital billboards customized for a targeted vehicle. United States Patent Application 20120054028 entitled METHOD OF ADVERTISING TO A TARGETED VEHICLE discloses a method of advertising to a targeted vehicle that involves, via a processor at a service center, determining at least one vehicle navigation route to a point of interest, and identifying a marketing agency that represents an entity that is at least one of i) associated with the point of interest, or ii) offering at least one of goods or services directed toward at least one occupant of the targeted vehicle traveling along the vehicle navigation route(s). The method further involves offering, to the marketing agency, advertisement space on a medium external to the targeted vehicle and located along the vehicle navigation route(s). Upon receiving an acceptance of the offer, via the processor at the service center, a command is submitted to a third party facility to display an advertisement of the marketing agency on the medium, where the advertisement is directed to the targeted vehicle. Implementation of targeted advertising systems will require large investments to install digital displays along highway routes. Such systems cannot interrelate digital content to the existing inventory of physical form media comprising millions of billboards and other signage deployed along the nation's highways and city streets.

Currently, actions required to obtain additional information related to physical form media are at best indirect. Depending on the relative motion of the observer to the presented physical form media, details required to act on a presented message may be missed altogether. Present methods do not provide direct access to richer information content related to physical form media, nor do they address the problem of reaching and communicating an extended message to a public that is not actively searching for a particular business, product, event, or service. Currently, over 1 billion people carry communication devices capable of providing a rich environment for the convergence of mobility and Web content. Thus, an apparatus and associated method(s) are needed to directly interrelate observed physical form media with information rich digital content accessible on an Internet website, data storage device, or social network using a remote, mobile device.

### SUMMARY OF THE INVENTION

According to a first broad aspect, the present invention provides computer-readable media tangibly embodying a program of instructions executable by a registrar device to implement a method, the registrar device being capable of interfacing with a communications network adapted to provide registered images of physical form media to a plurality of mobile devices connectable to the communication network, the method comprising: registering on a registrar device digital images of physical form media, receiving at the registrar device geospatial coordinates of a mobile device, transmitting to the mobile device from the registrar device registered digital images of physical form media observable at the received geospatial coordinates, including hyperlinks in registered digital images enabling access to digital content related to physical form media, the digital content being accessible to the mobile device on storage servers connected to the communications network.

According to a second broad aspect, the present invention provides a method for use in a communications network adapted to provide registered images of physical form media to a plurality of mobile devices connectable to the communication network, comprising: registering on a registrar device digital images of physical form media, receiving at the registrar device geospatial coordinates of a mobile device, transmitting to the mobile device from the registrar device registered digital images of physical form media observable at the received geospatial coordinates, including hyperlinks in registered digital images enabling access to digital content related to physical form media, the digital content being accessible to the mobile device on storage servers connected to the communications network.

According to a third broad aspect, the present invention provides a system for use in a communications network adapted to provide registered images of physical form media to a plurality of mobile devices connectable to the communication network, comprising: an interface for registering on a registrar device digital images of physical form media, a distributor for storing and sending to the plurality of mobile devices an application program for accessing the registrar device, a receiver for receiving at the registrar device geospatial coordinates of a mobile device, a transmitter for transmitting to the mobile device from the registrar device registered digital images of physical form media observable at the received geospatial coordinates, an input for including hyperlinks in registered digital images enabling access to digital content related to physical form media, the digital content being accessible to the mobile device on storage servers connected to the communications network.

According to a fourth broad aspect, the present invention provides a registrar device for use in a communications network adapted to provide registered images of physical form media to a plurality of mobile devices connectable to the communication network, comprising: an interface for registering on the registrar device digital images of physical form media, a receiver for receiving at the registrar device geospatial coordinates of a mobile device, a transmitter for transmitting to the mobile device from the registrar device registered digital images of physical form media observable at the received geospatial coordinates, an input for including hyperlinks in registered digital images enabling access to digital content related to physical form media, the digital content being accessible to the mobile device on storage servers connected to the communications network.

The present invention is directed to providing an apparatus and associated method(s) for interrelating observed physical form media with digital content accessible on an Internet website, data storage device, or social network, wherein the digital content includes at least one of text, images, audio, and video. More particularly, the present invention is directed to providing a registrar device connectable to a communication network accessible to at least one remote mobile device, the registrar device including an access control for controlling electronic access to the registrar device, an operating control for controlling registration and delivery of images of physical form media, and a storage for retaining digital files. The storage is configured to receive at least one digital image representing a physical form medium, geospatial coordinates for the medium, directional (viewing) orientation of the medium, and a Uniform Resource Locator linking the digital image to stored digital content. The digital content is accessible over the communication network by the at least one remote mobile device, when that remote mobile device is physically located in the vicinity of the physical form medium within a predetermined range. The remote mobile device is configured with at least a GPS receiver, a storage for retaining digital files, a display, and a control that when actuated transmits to the registrar device current geospatial coordinates determined by GPS or proximity to cell towers for the remote mobile device. The remote mobile device is configured for communication with the registrar device using an application program comprising an instruction set received from a distributor device that stores the application program. The control may be visible and touch or voice activated. The registrar device receives the geospatial coordinates and transmits to the remote mobile device the at least one digital image and Uniform Resource Locator. An affiliate identifier for the registrar device may be included with a hyperlinked Uniform Resource Locator. The stored digital content is accessible to the remote mobile device using the Uniform Resource Locator hyperlinked to the digital image. The remote mobile device may be at least one of a personal mobile communication device and a mobile communication device integrated into a transport vehicle. The mobile communication device may be interfaced with communication systems integrated into an automotive transport vehicle, the interface using for example a wired connection such as USB or a wireless connection using the Bluetooth standard. The remote mobile device may include a camera capable of producing digital images having image file headers that include at least geospatial coordinates. Activation of the hyperlink may be initiated by touching a displayed digital image or reciting a voice command, where the command may include a name or phrase related to the digital image or a number visible on the digital image.

In another embodiment, a plurality of digital images with hyperlinked Uniform Resource Locators are transmitted to the remote mobile device and presented as a scrollable picture array or “picture box” with endpoint digital images in the array or “picture box” corresponding to physical form media located at endpoints of the predetermined range and a most centered position in the array or “picture box” occupied by a digital image corresponding to a physical form medium located within the predetermined range and having geospatial coordinates nearest to the geospatial coordinates for emote mobile device. The digital images presented in the scrollable picture array or “picture box” are hyperlinked to stored digital content located on a plurality of storage devices accessible over the communication network. Activation of the hyperlink may be initiated by touching a displayed digital image or reciting a voice command, where the command may include a name or phrase related to the digital image or a number visible on the digital image.

In another embodiment, the most centered position presented in the scrollable picture array or “picture box” shifts to another digital image as the remote mobile device relocates to geospatial coordinates closer to a different physical form medium. The positioning of each image of the digital images in the scrollable picture array or “picture box” may be ordered by the relative distance between the geospatial coordinates of the remote mobile device and the geospatial coordinates of each of the physical form media corresponding to each digital image. The remote mobile device generates a route vector indicating a direction of motion of the remote mobile device and transmits the route vector to the registrar device. The digital images are added to the scrollable picture array or “picture box” representing physical form media located within the predetermined range in the direction of motion of the remote mobile device and digital images are deleted from the scrollable picture array or “picture box” when the geospatial coordinates of their corresponding physical form media are no longer within the predetermined range. The digital images within any instant predetermined range can be saved on command, either touch or verbal, in the storage of the remote device.

In another embodiment, the scrollable picture array “picture box” is one of autopanning or perpetual panning and may scroll vertically or horizontally. Autopanning is initiated by touching an image combined with a gesture in the direction of desired panning. Perpetual panning scrolls the picture array or “picture box” continuously at a predetermined rate which may be adjusted by the user.

In another embodiment, a plurality of digital mages with hyperlinked Uniform Resource Locators are transmitted to the remote mobile device and presented as a slideshow with endpoint digital images in the slideshow corresponding to physical form media located at endpoints of the predetermined range and a most centered or top-most (first image displayed) position in slideshow occupied by a digital image corresponding to a physical form medium located within the predetermined range and having geospatial coordinates nearest to the geospatial coordinates for the remote mobile device. The digital images presented in the slideshow are hyperlinked to stored digital content located on a plurality of storage devices accessible over the communication network. Activation of the hyperlink may be initiated by touching a displayed digital image or reciting a voice command, where the command may include a name or phrase related to the digital image or a number visible on the digital image.

In another embodiment, the most centered or top-most (first displayed) position presented in the slideshow shifts to another digital image as the remote mobile device relocates to geospatial coordinates closer to a different physical form medium. The positioning of each image of the digital images in the slideshow may be ordered by the relative distance between the geospatial coordinates of the remote mobile device and the geospatial coordinates of each of the physical form media corresponding to each digital image. The remote mobile device generates a route vector indicating a direction of motion of the remote mobile device and transmits the route vector to the registrar device. The digital images are added to the slideshow representing physical form media located within the predetermined range in the direction of motion of the remote mobile device and digital images are deleted from the slideshow when the geospatial coordinates of their corresponding physical form media are no longer within the predetermined range. The digital images within any instant predetermined range can be saved on command, either touch or verbal, in the storage of the remote device.

In another embodiment, the slideshow displays images either as an automatic or manual slideshow, with each image faded into view over the previous image. A touch activated control may be used to play, pause, or step through to a specific image within the slideshow. In automatic mode, the number of rotation cycles may be set to continuous or a specific number of rotations.

In another embodiment, at least one digital image representing a physical form medium, the geospatial coordinates for the medium, directional (viewing) orientation of the medium, and Uniform Resource Locator linking the image to stored digital content are transmitted subject to permission by the access control to the registrar device from at least one database resident on a remote storage device. The access control may include a payment acceptor for collecting a registration fee for registering the digital image representing the physical form medium. The geospatial coordinates for the medium may be included in an image file header for the digital image and the Uniform Resource Locator is a hyperlink in the digital image. The Uniform Resource Locator provides a link for the digital image to digital content resident on a social network or publicly accessible website or storage device.

In another embodiment, at least one digital image representing a physical form medium, the geospatial coordinates for the medium, directional (viewing) orientation of the medium, and the Uniform Resource Locator linking the image to stored digital content are transmitted subject to permission by the access control to the registrar device from at least one remote mobile device among a plurality of remote mobile devices. The geospatial coordinates for the medium may be included in an image file header for the digital image and the Uniform Resource Locator is a hyperlink in the digital image. The Uniform Resource Locator provides a link for the digital image to digital content resident on a social network or publicly accessible website or storage device. The access control may include a payment acceptor for collecting a registration fee for registering the digital image representing the physical form medium.

In another embodiment, the operating control of the registrar device creates a “click through” record for each linking to the digital content using the hyperlinked digital images from at least one remote mobile device, the “click through” record including an identifier of the registrar device (e.g. Affiliate ID), an identifier of the remote mobile device (e.g., telephone number), and an identifier of the social network or publicly accessible website or storage device.

In another embodiment, the registrar device includes a media selector-comparator for selecting at least one medium from the media registered on the registrar device and subsequently comparing elements in the “click through record” with the at least one selected medium. The at least one selected medium is identified with at least one of a special event, condition, or reward, where selection of a specific medium and its relationship with the elements of the “click through record” and the special event, condition, or reward is governed by a variable rule set.

In another embodiment, the registrar device may be one of a web hosted machine or a virtual machine. A Web host can have anywhere from one to several thousand computers (machines) that run Web hosting software. A virtual machine (VM) is an environment, usually a program or operating system, which does not physically exist but is created within another environment (e.g., Java runtime). One host environment can often run multiple VMs at once.

In another embodiment, the present invention is directed to providing an explicit method of linking over a communication network digital content stored on a storage device to digital images representing physical form media, the method comprising providing a registrar device connectable to the communication network and accessible to a plurality of remote mobile devices, the registrar device including an access control for controlling electronic access to the registrar device, an operating control for controlling registration and delivery of images of physical form media, and a storage for retaining digital files. The method includes receiving at the storage a plurality of digital images representing physical form media, geospatial coordinates for the media, directional (viewing) orientation of the medium, and Uniform Resource Locators linking the images to digital content stored on a plurality of remote storage devices accessible over the communication network. The method includes transmitting current geospatial coordinates for the remote mobile devices to the registrar device, receiving the coordinates by the registrar device and transmitting to the remote mobile devices the plurality of digital images with the Uniform Resource Locators hyperlinked to the digital images, and presented on each remote mobile device as a scrollable array, a “picture box” or a slideshow. An affiliate identifier for the registrar device may be included with the hyperlinked Uniform Resource Locator. The scrollable array, “picture box” or slideshow may be configured with endpoint digital images corresponding to physical form media located at endpoints of the predetermined range, positioning of each image of the plurality of digital images in the scrollable array, “picture box” or slideshow ordered by the relative distance between the geospatial coordinates of the remote mobile device and the geospatial coordinates of each physical form medium corresponding to each digital image. The most centered position in the scrollable array, “picture box” or slideshow is generally occupied by a digital image corresponding to a physical form medium located within the predetermined range and having geospatial coordinates nearest to the geospatial coordinates for the remote mobile device. The method includes providing an instruction set to the remote mobile devices, the instruction set configuring each of the remote mobile devices to at least generate current geospatial coordinates and a route vector indicating a direction of motion of each of the remote mobile devices and transmitting the geospatial coordinates and route vector to the registrar device. The method includes adding digital images to the scrollable array, “picture box” or slideshow representing physical form media located within the predetermined range in the direction of motion of the remote mobile device, and deleting digital images from the scrollable array, “picture box” or slideshow when the geospatial coordinates of their corresponding physical form media are no longer within the predetermined range. The method includes accessing the stored digital content by the remote mobile devices using the Uniform Resource Locators hyperlinked to the digital images, when the remote mobile devices are physically located in the vicinity of the media within a predetermined range. The most centered position presented in the scrollable array, “picture box” or slideshow shifts to another digital image as the remote mobile device relocates to geospatial coordinates closer to a different physical form medium, and each of the remote mobile devices is configured with at least a GPS receiver, a storage for retaining digital files, a display, and a control, where the control may be a visible icon displayed on the remote mobile device. Activation of the hyperlink may be initiated by touching a displayed digital image or reciting a voice command, where the voice command may include a name or phrase related to the digital image or a number visible on the digital image. The images displayed in the scrollable array or “picture box” may be autopanning or perpetual panning. Image display in the slideshow may be set for automatic rotation or manual rotation.

In one embodiment of the method, at least one digital image representing a physical form medium, the geospatial coordinates for the medium, directional (viewing) orientation of the medium, and the Uniform Resource Locator linking the image to stored digital content is transmitted subject to permission by the access control to the registrar device from at least one database resident on a remote storage device. A plurality of digital images related to the image representing the physical form medium may also be accepted and registered, each image in the plurality of digital images accepted and registered including a Uniform Resource Locator and an identifier of the physical form medium to which it is related. At least one audio sound bite, comprising a short audio message related to an image representing a physical form medium, may also be received, accepted and registered.

In another embodiment of the method, at least one digital image representing a physical form medium, the geospatial coordinates for the medium, directional (viewing) orientation of the medium, and the Uniform Resource Locator linking the image to stored digital content is transmitted subject to permission by the access control to the registrar device from at least one remote mobile device among a plurality of remote mobile devices. The geospatial coordinates for the medium are included in an image file header for the digital image and the Uniform Resource Locator is a hyperlink in the digital image.

In another embodiment of the method, the Uniform Resource Locator links the digital image to digital content resident on a social network or publicly accessible website or storage device. The operating control may create a “click through” record for each action linking to the digital content using the hyperlinked digital images from at least one remote mobile device, the “click through” record including an identifier of the registrar device (e.g., Affiliate ID), an identifier of the remote mobile device and an identifier of the social network or publicly accessible website or storage device.

In another embodiment of the method, the registrar device selects using a media selector-comparator at least one medium from the media registered on the registrar device and subsequently compares elements in the “click through record” with the at least one selected medium. The at least one selected medium is identified with at least one of a special event, condition, or reward, where selection of a specific medium and its relationship with the elements of the “click through record” and the special event, condition, or reward is governed by a variable rule set.

In another embodiment of the method, the operating control registration of physical form media may incorporate an International Billboard Identity (IBI) for said media. Registration of physical form media (e.g., billboards) may comprise a first registration of the media using the IBI and geospatial location, absent specific image displays. Registration fees may be collected from the “owner” of the media or the owners' agents. Subsequent registrations of specific image displays on physical form media may reference the IBI for the media presenting the image displays. The registration of specific image displays may also include a number, name or phrase relating to the visual content displayed on the physical media during any specific period. Registration fees for registering specific image displays may be collected from advertisers (e.g. Intel, McDonalds, Bubba's Bar-B-Que) or their agents (e.g. Lamar, Clear Channel, CBS Outdoor).

In another embodiment of the method, the registrar device may receive from bile device the International Billboard Identity (IBI) or other unique identifier for specific media. Images on physical form media (e.g., billboards) registered with a corresponding IBI or unique identifier are returned to the mobile device.

In another embodiment of the method, the registered image sent to the remote mobile device from the registrar device may be time synchronized with images displayed periodically on a physical form digital display medium, such that the image visible on the physical form digital display medium at the approximate time the remote mobile device was closest to the display medium is the image sent. Alternatively, all of the images (usually 6 or 7 images) each periodically displayed on a physical form digital display medium may be sent to the remote mobile device from the registrar device.

In one aspect of the present invention, abbreviated information present in a physical form on physical media (or in natural objects) is associated with related detailed information remotely stored in electronic virtual form in social media or other publically accessible websites or storage devices. Association of physical form information with virtual form information is accomplished via mobile devices that may be configured with a camera, graphical display, an application instruction set (e.g., mobile app), a Global Positioning System (GPS) receiver, and public network access. A digital image of a presentation on a physical medium (or a natural object) may be captured by a camera in the mobile device and linked (geotagged) by the instruction set to geo-spatial location coordinates of the mobile device detected at the date and time the photographic image is created. The instruction set creates an image file in Exchangeable Image File Format (EXIF) that includes at least the geo-spatial location coordinates, date, and time. The GPS receiver detects the geo-spatial location coordinates, date, and time. Location coordinates, date, time, and image in EXIF are uploaded to and registered on a registrar device (e.g., web server), along with an identification of the specific physical medium (or natural object), and directional (viewing) orientation of the medium. The identification of a physical medium (or natural object) may comprise a name, number, or any other unique identifier. Secure “Login” and user account authentication are required in order to register a photographic image to the registrar device. The registrar device may store the image received or create and store a reduced scale image (e.g., thumbnail) with a registrant defined hyperlink to associated virtual form information located in registrant designated social media websites or other publically accessible website or storage device. The digital image may be uploaded to the designated websites.

In another aspect of the present invention, user access to virtual form information associated with specific physical form presentations (and natural objects) is accomplished via mobile devices configured with a graphical display, an application instruction set (e.g., mobile app), a GPS receiver, and public network access. When a user encounters a physical form presentation (or natural object) of interest, selecting a named application icon (visible control) on the user interface of a configured mobile device initiates determination of geospatial location coordinates of the mobile device at that time and location coordinates are uploaded to the registrar device. Reduced scale images of registered natural objects and physical form media, located within a pre-determined range of the uploaded geo-spatial location coordinates, are returned to the mobile device and displayed. The pre-determined range may be made user adjustable. Altering the range limit may result in a change in the number of registered images downloaded. The registered images are associated via hyperlinks with virtual form information located in the social media or other publically accessible web site or storage device. User selection (e.g., touching, reciting a related name) of an image initiates linking to a specific web site landing page or information profile on the social media website, or other publically accessible web site or storage device, enabling download and presentation of the associated virtual form information. User login to the registrar device need not be required to access registered images.

In another aspect of the present invention, an instruction set configures at least one remote mobile device with an image table or list for accepting from the registrar device at least one name, phrase, or number correlated with at least one registered digital image representing a physical form medium, and a Uniform Resource Locator for a social media site, or other publically accessible web site or storage device having digital content related to the image presented on the physical form medium. The digital content is accessible to the remote mobile device on storage servers at the sites connected to the communications network. Reciting in a verbal command the at least one name, phrase or number accepted into in the image table activates, using the Uniform Resource Locator, connection of the remote mobile device to the site having the digital content related to the image presented on the physical form medium. A plurality of names and Uniform Resource Locators may be accepted into the image table or list, each name correlated with a digital image of a physical form medium and each associated Uniform Resource Locator corresponding to the network address of the social media site or other publically accessible web site or storage device having digital content related to the image presented on the physical form medium and represented by the digital image.

In another aspect of the present invention, an instruction set configures at least one remote mobile device having requisite voice capability to recite at least one name, phrase, number or audio sound bite correlated with at least one registered digital image representing a physical form medium, the at least one name, phrase, number or audio sound bite having been received from the registrar device and stored in an image table or list, or associated internal storage.

In another embodiment, a remote mobile device of the present invention may comprise a mobile communication device (e.g., OnStar, SYNC) integrated into a transport vehicle such as an automobile. The integrated mobile communication device may share at least a part of the feature set of the personal mobile device of the present invention. Position and transit direction information may be accumulated by a dedicated GPS receiver. Alternatively, at least position and transit direction information may be accessed from a vehicle event data recorder such as prescribed in Section 31406 of U.S. Senate Bill 1813 enacted in the 112^{th} Congress, 2012. Authenticating information for the user and vehicle may also be accessed from the vehicle event data recorder. The digital content returned to and displayed by the integrated mobile communication device corresponds to at least the information accessed from the vehicle event data recorder or a dedicated GPS receiver.

In another aspect, a remote mobile device of the present invention may also be interfaced with an integrated mobile communication device (e.g., OnStar, SYNC) in an automotive vehicle using a wired connection such as USB or a wireless connection such as for example that provided by the Bluetooth standard. Bluetooth is essentially a networking standard that works at two levels: it provides agreement at the physical level—Bluetooth is a radio-frequency standard; and it provides agreement at the protocol level, where products have to agree on when bits are sent, how many will be sent at a time, and how the parties in a conversation can be sure that the message received is the same as the message sent.

A mobile communication device of the present invention configured for wireless connections using the Bluetooth standard can be paired with an integrated communication device (e.g., OnStar, SYNC) in an automotive vehicle in accordance with the Bluetooth specification. A voice command reciting the named visible control can be used to activate using the integrated communication device connection of the mobile communication device with the registrar device resulting in transmission of the geo-spatial coordinates of the device to the registrar device, and return of registered images displayed on physical form media located in the vicinity of the transmitted coordinates. The images may be displayed on vehicles integrated communication device or the mobile communication device.

The present invention can be interfaced with the Ford SYNC technology that provides drivers with the ability to operate Bluetooth-enabled mobile phone and digital media players in their vehicles using voice commands, the vehicle's steering wheel or radio controls. AppLink† allows BlackBerry, iPhone, and Android based phones to run approved applications using the Ford SYNC interface and a car's steering wheel buttons, radiohead, and/or voice commands.

In some embodiments, the instruction set of the present invention may provide controls for configuring an integrated communication device or a mobile communication device into a monitoring mode to substantially continuously interact with the registrar device such that registered images that come into the predetermined range as a vehicle moves are displayed.

### BRIEF DESCRIPTION OF THE DRAWINGS

FIG. 1A is a non-limiting drawing showing how the apparatus of the present invention interrelates physical form media to stored digital content accessible over a communication network.

FIG. 1B is a non-limiting drawing showing how the apparatus of the present invention differentiates viewable physical form media for presentation on remote devices and connection to stored digital content accessible over a communication network.

FIG. 2A, FIG. 2B and FIG. 2C collectively comprise a non-bruiting diagram of a method of adjoining over a communication network digital content stored on a storage device to digital images representing physical form media.

FIG. 3A is non-limiting diagram depicting a top level configuration of the registrar device and connections to other types of devices.

FIG. 3B is non-limiting diagram depicting a configuration of the registrar device and typical storage content.

FIG. 4 is a non-limiting diagram depicting a configuration of the remote device.

FIG. 5 is a non-limiting diagram depicting a scrollable picture array displayed on the remote device and an image able configurable in the remote device. A similar scrollable display of images can be achieved with a “picture box” or slideshow.

FIG. 6 is a non-limiting diagram depicting a remote mobile device of the present invention interfaced with a communication and control device integrated into a transport vehicle and where optionally the transport vehicle may also be equipped with a vehicle data recorder.

### DETAILED DESCRIPTION OF PREFERRED EMBODIMENTS OF THE INVENTION

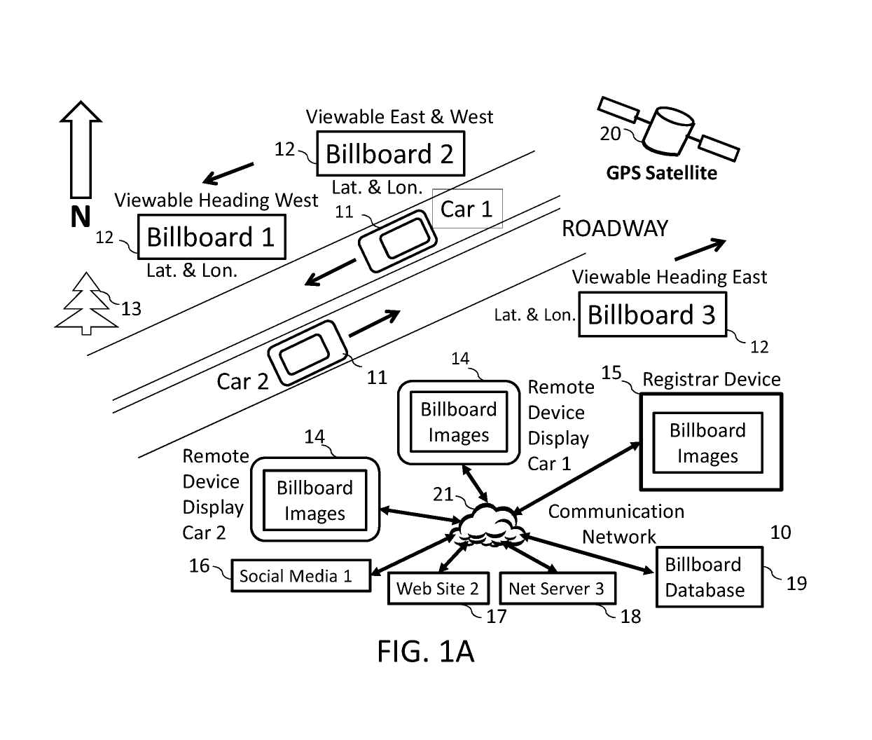

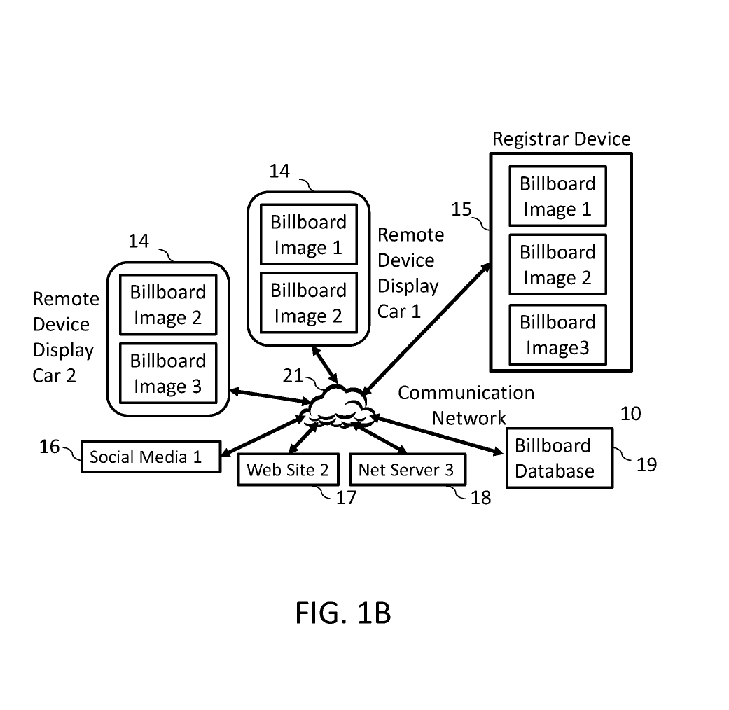

In brief: FIG. 1A is a non-limiting drawing showing how the apparatus of the present invention interrelates physical form media (or natural image scene) to stored digital content accessible over a communication network by enabling an observer of information presented in physical media or a natural scene to directly access associated virtual form information using a mobile device by selecting (e.g., touching, verbal command) a named icon activating an instruction set that initiates detection of the geo-physical location of the mobile device and results in download from the registrar device digital images related to images displayed on registered physical media located within a pre-determined range of the mobile device.

FIG. 1B is a non-limiting drawing showing how the apparatus of the present invention differentiates viewable physical form media for presentation on remote devices and connection to stored digital content accessible over a communication network. Activation the instruction set results in download of only those digital images related to physical form media viewable in the direction of vehicle motion. Selecting (e.g., touching, verbal command) the digital image of physical media or natural scene of interest to the observer results in direct presentation of related information in virtual (digital) form downloaded from social media, a web site, or other network storage device. The digital content presented may be in visual and/or audio format.

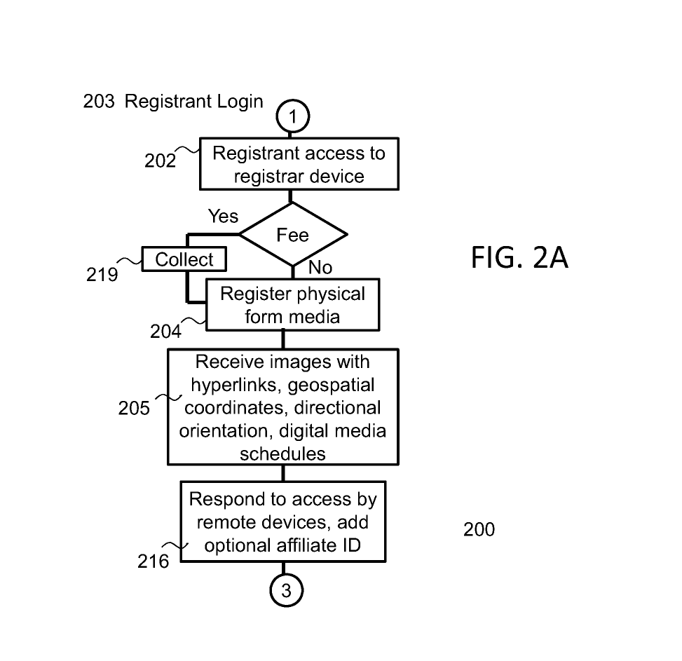

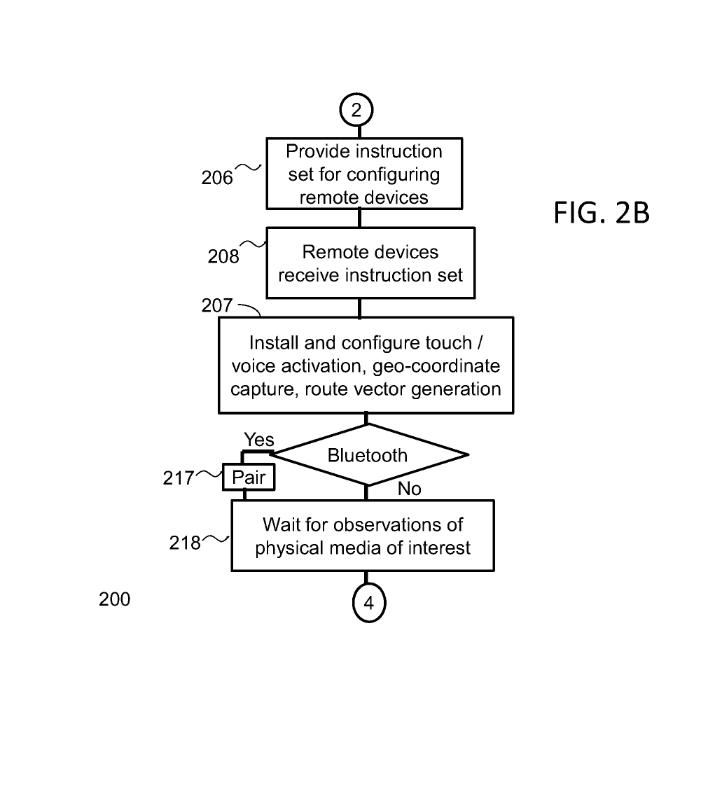

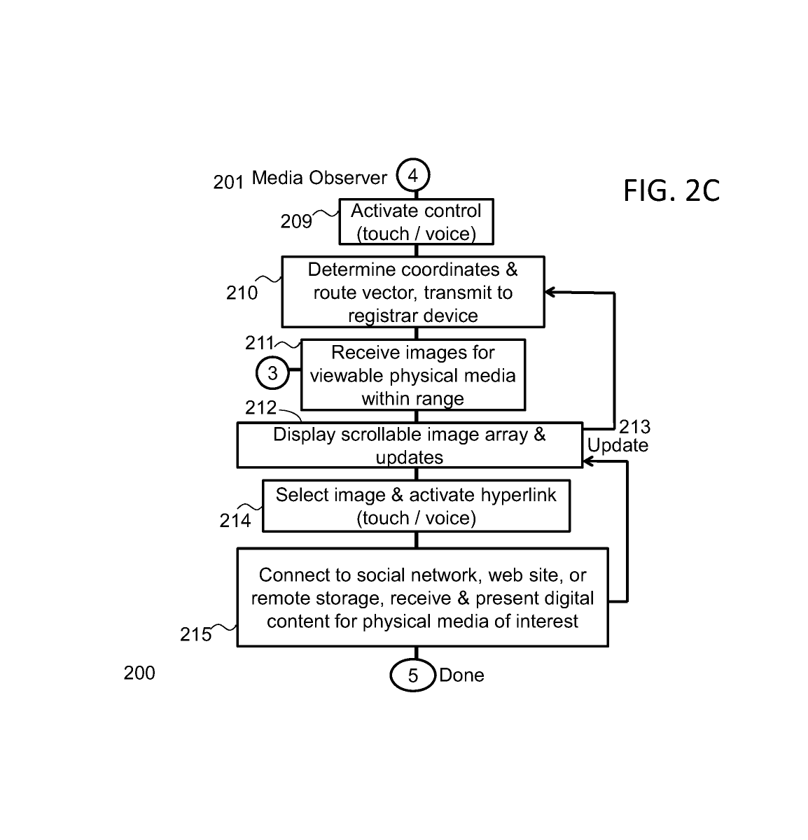

FIG. 2A, FIG. 2B and FIG. 2C collectively comprise a diagram of a method of connecting over a communication network digital content stored on a storage device to digital images representing physical form media by dynamically and directly associating physical form information observed from various perspectives in a particular place or presented on a physical medium in a particular location to information stored remotely in a virtual medium, and enabling “single touch” or “single command” access to the virtual form information associated with the observed physical form information when an observer encounters physical form information of interest.

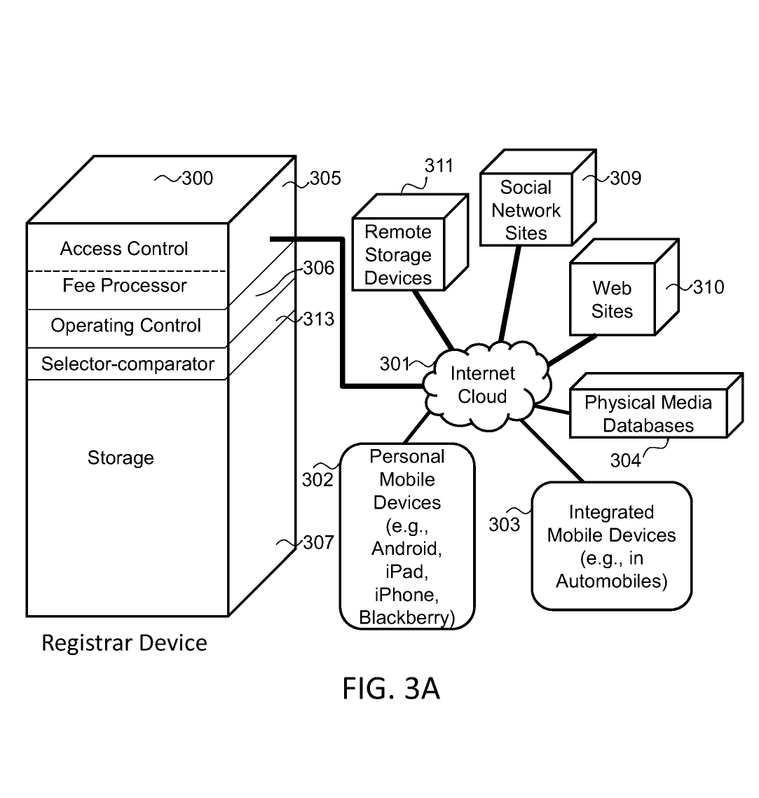

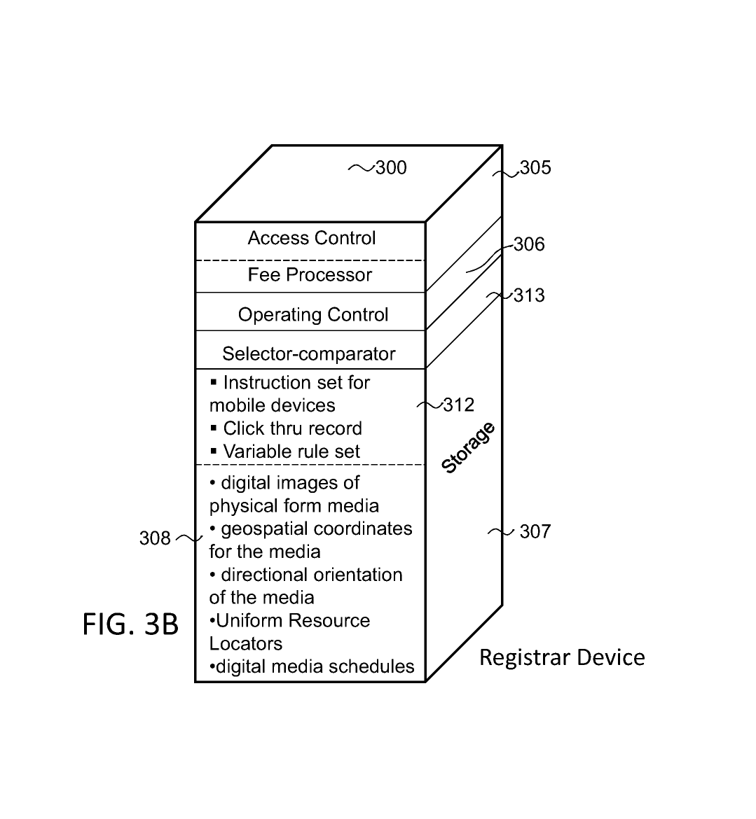

FIG. 3A is diagram depicting a configuration of the registrar device connectable to a communication network accessible to at least one remote device and connectable to at least remote storage devices storing digital content and images of physical form media, the registrar device including an access control for controlling electronic access to the registrar device, an operating control for controlling registration and delivery of images of physical form media, and a storage for retaining digital files.

FIG. 3B is diagram depicting a configuration of the registrar device configured to receive at least one digital image representing a physical form medium, geospatial coordinates for the medium, directional (viewing) orientation of the medium, and a Uniform Resource Locator linking the digital image to stored digital content.

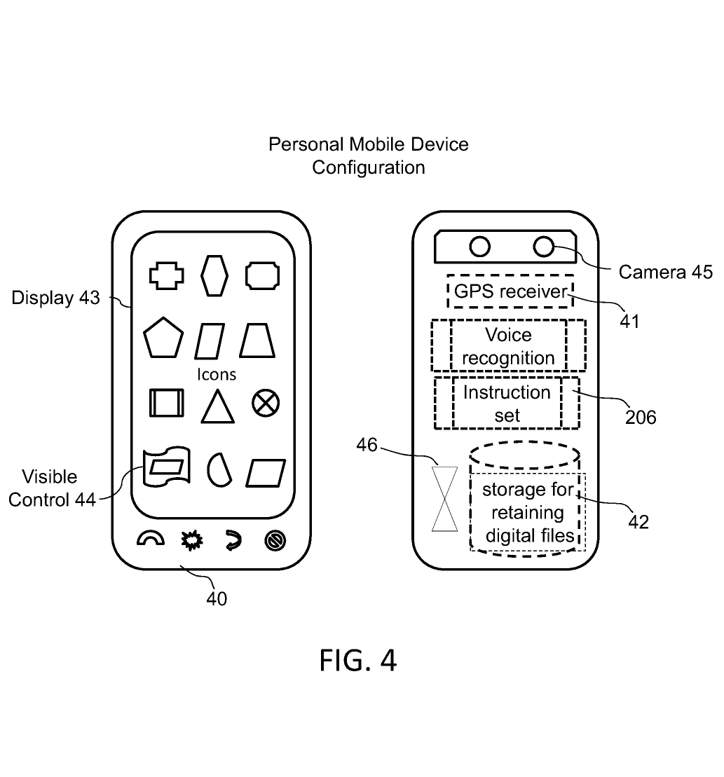

FIG. 4 is a diagram depicting a configuration of a remote device configured with at least a GPS receiver, a storage for retaining digital files, a display, and a visible control that when actuated transmits current geospatial coordinates for the remote device to the registrar device and receives from the registrar device at least one digital image of an observed physical from medium and a Uniform Resource Locator for a remote storage site where digital content related to the physical form medium is stored. The remote device may be Bluetooth enabled for localized communication.

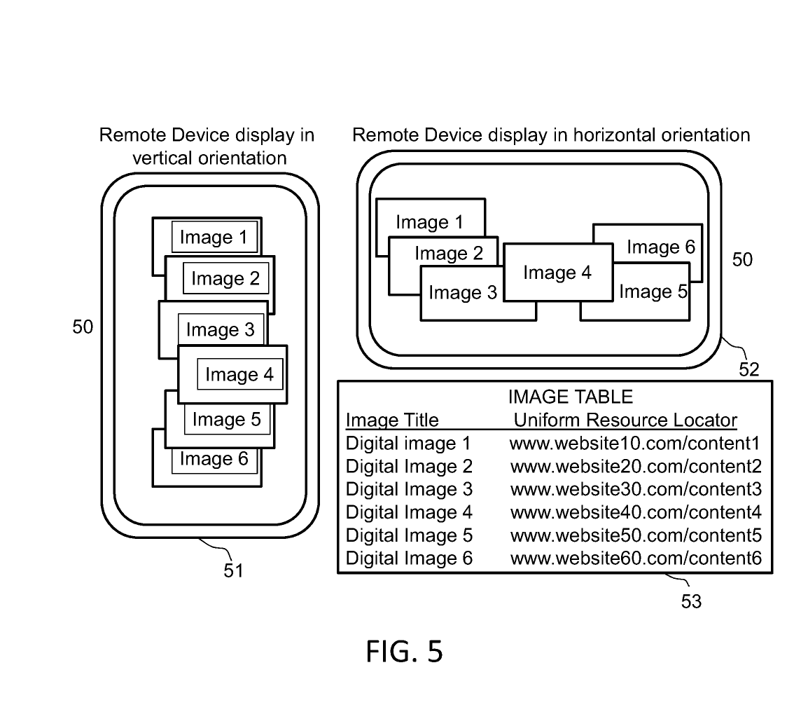

FIG. 5 is a diagram depicting a scrollable picture array displayed on the remote device with images of physical form media oriented to scroll vertically when the longer dimension of the device is oriented vertically and to scroll horizontally when the longer dimension of the remote device is oriented horizontally. Also depicted is an image table for accepting from the registrar device at least one name or number correlated with at least one registered digital image representing a physical form medium, and a Uniform Resource Locator for a social network site, web site, or network storage site having digital content related to the image presented on the physical form medium. Reciting in a verbal command the at least one name or number accepted into in the image table activates, using the Uniform Resource Locator, connection of the remote mobile device to the social media, web site, or storage device having the digital content related to the image presented on the physical form medium. A remote device having requisite voice capability may be configured to recite at least one name, phrase, or number correlated with at least one registered digital image representing a physical form medium, the at least one name, phrase, or number having been received from the registrar device and stored in the image table or list.

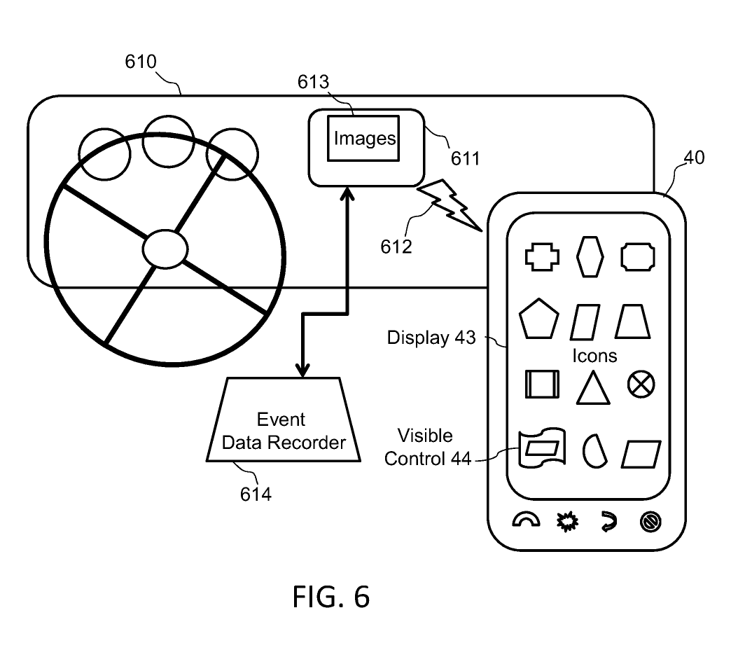

FIG. 6 is a diagram depicting a remote mobile device of the present invention interfaced with a communication device integrated into a transport vehicle and where the transport vehicle may also be equipped with a vehicle data recorder. The remote mobile device may comprise at least a display, communication, wireless connection (e.g., Bluetooth) and voice recognition feature set, with position, transit direction provided by a dedicated or shared GPS unit, or alternatively a vehicle data recorder.

In detail: Referring now to FIG. 1A, there is shown a non-limiting schematic illustration of one embodiment of the present invention 10 illustrating how the apparatus of the present invention interrelates physical form media to stored digital content accessible over the communication network 21. The present invention enables an observer 11 of information presented in physical media 12 or a natural scene 13 to directly access associated virtual form information with a “single touch” or “single command” of a named application icon (control) that may be displayed on a remote mobile device 14. The remote mobile device may be a communication device integrated into an automotive vehicle or a personal communication device. Selecting the named application icon activates an instruction set operational in the remote mobile device 14 that initiates detection of the geo-physical location (Lat. & Lon.) of the remote mobile device 14 using an internal GPS receiver receiving signals from GPS satellites 20 to determine its position and results in download from the registrar device 15 of full or reduced form (e.g., thumbnail) digital images depicting physical form images displayed on registered physical media 12 located within a pre-determined range of the remote mobile device 14. A “verbal command” naming the digital image or a “single touch” on the digital image of physical media 12 or natural scene 13 of interest to the observer 11 results in direct presentation of related information in virtual (digital) form downloaded from social media 16, a web site 17, or other network storage device 18. In some cases, information content may download automatically from the social media 16, web site 17, or other network storage device 18 absent further user action. The content presented may be in visual or audio format.

Referring to FIG. 1A and FIG. 1B, in another embodiment, a plurality of digital images with hyperlinked Uniform Resource Locators may be transmitted to a remote mobile device 14 and presented as a scrollable picture array, a “picture box” or a slideshow. The remote mobile device 14 may be configured such that the endpoint digital images in the scrollable array, “picture box” or slideshow correspond to physical form media located at endpoints of the predetermined range and a most centered position in the scrollable array, “picture box” or slideshow is occupied by a digital image corresponding to a physical form medium 12 located within the predetermined range and having geospatial coordinates nearest to the geospatial coordinates for the remote mobile device 14. The digital images presented in the scrollable array, “picture box” or slideshow are hyperlinked to stored digital content located on a plurality of storage devices accessible over the communication network.

The registrar device 15 receives the geospatial coordinates from a remote mobile device 14 and transmits to the remote mobile device 14 the at least one digital image and Uniform Resource Locator. An affiliate identifier for the registrar device 15 may be included with a hyperlinked Uniform Resource Locator. The stored digital content is accessible to the remote mobile device 14 using the Uniform Resource Locator hyperlinked to the digital image.

A hyperlink is a reference from one document to another. A document (aka hypertext or hypermedia) is a text, video, or audio file, or a gateway to a service. Documents may contain hyperlinks to each other. A hyperlink reference may contain 2 parts: on screen, the user sees some text or an image that is distinct from non-hyperlink text/images (e.g. underlining). Hidden from the user, there's an ‘address’ pointing to the referenced document.

A Uniform Resource Locator (URL) is an address that supports a hyperlink. The user needn't see this, only the text/image representation on screen. A URL is essentially a networked extension of the standard filename concept: not only can it point to a file in a directory, but that file and that directory can exist on any machine on the network, can be served via any of several different methods, and might not even be something as simple as a file: URLs can also point to queries, documents stored deep within databases, the results of a finger or archie command, or digital content. It is possible to represent any file or service on the Internet with a URL. Every resource available on the Web—HTML document, image, video clip, program, etc.—has an address that may be encoded by a Uniform Resource Locator, or “URL”. URLs typically consist of three pieces:
1. The naming scheme of the mechanism used to access the resource.
2. The name of the machine hosting the resource.
3. The name of the resource itself, given as a path.

In another embodiment referring to FIG. 1A and FIG. 1B, at least one digital image representing a physical form medium 12, the geospatial coordinates (Lat. & Lon.) for the medium, directional (viewing orientation (East West, North/South bi-directional) of the medium, and Uniform Resource Locator linking the image to stored digital content are transmitted subject to permission by the access control [see FIG. 3A] to the registrar device 15 from at least one database 19 resident on a remote storage device. An IBI number may also be included. The database 19 may contain geospatial coordinates of a plurality of physical form media, correlated with their geospatial coordinates. The geospatial coordinates may remain fixed, while the images displayed on the physical form media may be changed from time-to-time, the database 19 updated with new corresponding digital images and Uniform Resource Locators, and the newly displayed images registered on the registrar device 15.

In another embodiment, at least one digital image representing a physical form medium 12, the geospatial coordinates (Lat. & Lon.) for the medium, directional (viewing) orientation (e.g., East/West, North/South, bi-directional) of the medium, and the Uniform Resource Locator linking the image to stored digital content are transmitted subject to permission by the access control (see FIG. 3A) to the registrar device 15 from at least one remote mobile device 14 among a plurality of remote mobile devices. The geospatial coordinates for the medium 12 are included in an image file header for the digital image and the Uniform Resource Locator is a hyperlink in the digital image. The Uniform Resource Locator links the digital image to digital content resident on a social network 16, publicly accessible website 17 or other network server 18.

In another embodiment, the operating control (see FIG. 3A) on the registrar device 15 creates a “dick through” record (see FIG. 3B) for each linking to the digital content using the hyperlinked digital images from at least one remote mobile device 14, the “dick through” record including an identifier of the registrar device 15 (e.g. Affiliate ID), an identifier of the remote device 14, and an identifier of the related web storage device 16, 17, or 18.

Referring now to FIG. 2A, FIG. 2B and FIG. 2C collectively, a non-limiting embodiment is shown in chart 200 as a block diagram for a method of adjoining over a communication network digital content stored on a storage device to digital images representing images displayed on physical form media. The method provides for dynamically and directly associating physical form information observed by an observer 201 (FIG. 2C) from various perspectives in a particular place (e.g., a landmark) or presented on a physical medium (e.g., a billboard, a building) in a particular location (Lat. & Lon.) to information stored remotely in a virtual medium (e.g., social network, website or other networked storage device), and enabling “single touch” or “single command” access to the virtual (digital) form information associated with the observed physical form information when an observer 201 (FIG. 2C) encounters physical form information of interest 218 (FIG. 28).

The method provides a registrar device 202 (FIG. 2A) connectable to said communication network and accessible to a plurality of remote devices operated by both registrants 203 (FIG. 2A) and observers 201 (FIG. 2C) of physical form media. The registrar device includes an access control (see FIG. 3A, 305) for controlling electronic access to the registrar device 202 (FIG. 2A), an operating control (see FIG. 3A, 305) for controlling registration 204 (FIG. 2A) and delivery of digital images 211 (FIG. 2C) depicting images displayed on physical form media, and a storage (see FIG. 3A, 305) for retaining digital files. The access control may include a fee processor 219 (FIG. 2A) for collecting registration fees. There are many different ways to accept fee payment. The most important one is the ability to accept credit cards online. An effective way to process credit cards is to have a merchant account with a gateway and process credit cards directly. Service providers are widely available and may include Authorize.net and Paypal Website Payments Pro.

Each remote mobile device is configured with at least a GPS receiver, a storage for retaining digital files, a display, and a control for activating connection 209 (FIG. 2C) to the registrar device over the communication network. [See FIG. 4.] Remote mobile devices may also be Bluetooth enabled and capable of pairing 217 (FIG. 28) with communication systems (e.g. OnStar, SYNC) integrated into an automotive vehicle. When paired with automotive communications systems such as OnStar or SYNC, features of those systems may be used to activate 209 (FIG. 2C) connection of a mobile device to the registrar device, as well as display images and provide information in audio and visual format. The Bluetooth pairing process is typically triggered automatically the first time a device receives a connection request from a device with which it is not yet paired. In order that Bluetooth pairing may occur, a password has to be exchanged between the two devices. This password or “Passkey” as it is more correctly termed is a code shared by both Bluetooth devices. It is used to ensure that both users have agreed to pair with each other. Bluetooth is a system which connections are made between a master and a slave. These connections are maintained until they are broken.

The method provides for registering 204 (FIG. 2A) at the registrar device and receiving 205 (FIG. 2A) at the storage a plurality of digital images representing physical form media, geospatial coordinates for said media, directional (viewing) orientation of the media, and Uniform Resource Locators linking the digital images to digital content stored on a plurality of remote storage devices accessible over the communication network [see FIG. 1B]. The IBI numbers for media may also be registered. An instruction set is provided 206 (FIG. 2A) to remote mobile devices operated by media observers 201 (FIG. 2C), the instruction set configuring 207 (FIG. 2B) each of the receiving 208 (FIG. 2B) remote mobile devices to capture geospatial coordinates and generate a route vector indicating a direction of motion of said remote mobile devices. The remote mobile device may also be configured 208 (FIG. 2B) for touch and voice activation of the control, depending on the specific functional capabilities of each model of remote mobile device.

The method provides for activating 209 (FIG. 2C) the control on a remote mobile device in order to access digital content relevant to physical form media of interest. The current geospatial coordinates and the route vector of a remote mobile device are transmitted 210 (FIG. 2C) from the remote mobile device to the registrar device when the control 209 (FIG. 2C) is activated on the remote mobile device. In some cases where the remote mobile device can acquire the IBI number for a specific medium, for example using a wireless connection with the medium, the IBI number may be transmitted to the registrar device. The method also provides for receiving 211 (FIG. 2C) at the at least one remote mobile device a set of viewable digital images from the plurality of digital images for registered physical media. The set of viewable digital images transmitted from the registrar device corresponds to physical media located within a predetermined range of the geospatial coordinates of the at least one remote mobile device. In some cases a viewable digital image returned may correspond to an IBI number received from the mobile device. The set of digital images may be presented 212 (FIG. 2C) on the display of the at least one remote mobile device as a scrollable array, a “picture box” or a slideshow [see FIG. 5]. The scrollable array, “picture box” or slideshow may be configured 212 (FIG. 2C) with endpoint digital images corresponding to physical form media located at endpoints of the predetermined range. The positioning of each image in the scrollable array, “picture box” or slideshow may be ordered by the relative distance between the geospatial coordinates of the remote device and the geospatial coordinates of each of the physical form medium corresponding to each digital image. The greater the difference in relative position, the closer the presentation of the digital image to the endpoint. The most centered position displayed 212 (FIG. 2C) in the scrollable array, “picture box” or slideshow may be occupied by a digital image corresponding to a physical form medium located within the predetermined range and having geospatial coordinates nearest to the geospatial coordinates for the remote mobile device. Display of the scrollable array or “picture box” may be configured 212 (FIG. 2C) for autopanning or perpetual panning. Autopanning is initiated by a touching and dragging motion 214 (FIG. 2C) on an image in the scrollable array or “picture box” and the displayed images move in the direction of the dragging motion left or right, or up or down, depending on the orientation of the remote mobile device and the number of images in the scrollable array or “picture box” (see FIG. 5). Perpetual panning scrolls the displayed 212 (FIG. 2C) images in the scrollable array or “picture box” continuously [essentially in a loop] at a predetermined rate which may be adjusted by the user. In a slideshow, images can be displayed either manually or automatically in a manner similar to the scrollable array or “picture box” or an image may be displayed by fading it into view over a previous one. A control may be used to play, pause, or step through to a specific image within the gallery of images presented in the slideshow. In automatic mode, the number of cycles may be set for continuous or a specific number of rotations. In monitoring mode, registered images that come into the predetermined range as a vehicle moves are automatically displayed.

Digital images representing physical form media located within the predetermined range may be added to update 213 (FIG. 2C) the scrollable array, “picture box” or slideshow as the digital images become viewable in the direction of motion of the at least one remote mobile device. Digital images may be deleted (update) 213 (FIG. 2C) from the scrollable array, “picture box” or slideshow when the geospatial coordinates of their corresponding physical form media are no longer within the predetermined range. The most centered position displayed 212 (FIG. 2C) in the scrollable array, “picture box” or slideshow shifts to another digital image as the remote mobile device relocates to geospatial coordinates closer to a different physical form medium. Selecting 214 (FIG. 2C) by touch or voice command an image displayed on the remote device activates a hyperlink in the selected image, connecting 215 (FIG. 2C) the remote device to a social network, web site, or network storage [see FIG. 1] using the Uniform Resource Locator to access digital content relevant to the content of the physical form medium depicted in the selected image. A voice command 214 (FIG. 2C) may recite a name, phrase, or number which may be visible on a depicted image, initiating access to stored digital content using the Uniform Resource Locator hyperlinked in the digital images.

The at least one digital image representing a physical form medium, the geospatial coordinates for the medium, directional (viewing) orientation of the medium, an IBI number for the medium, and the Uniform Resource Locator linking the image to stored digital content may be accepted subject to permission 202 (FIG. 2A) by the access control on the registrar device [see FIG. 3A] and received from at least one database resident on a remote storage device 19 (FIG. 1A) and from at least one remote device 14 (FIG. 1A) among a plurality of remote devices. A plurality of digital images related to the image representing the physical form medium may also be accepted and registered, each image in the plurality of digital images accepted and registered including a Uniform Resource Locator and an identifier of the physical form medium to which it is related. The geospatial coordinates for a medium may be included in an image file header for the digital image and the Uniform Resource Locator is a hyperlink in the digital image. The Uniform Resource Locator links the digital image to digital content resident on a social network or publicly accessible website or storage 215 (FIG. 2C). An affiliate identifier for the registrar device may be included 216 (FIG. 2A) with the hyperlinked Uniform Resource Locator. Registration of physical form media (e.g., billboards) may incorporate an International Billboard Identity for the media. Registration of physical form media may comprise a first registration of the media using the International Billboard Identity (IBI) and geospatial location, absent specific image displays. Registration fees may be collected from the “owner” of the media or the owners' agents. Subsequent registrations of specific image displays on physical form media may reference the International Billboard Identity (IBI) for the media presenting the image displays. The registration of specific image displays may also include a number, name or phrase relating to the visual content displayed on the physical media during any specific period. Registration fees for registering specific image displays may be collected from advertisers (e.g. Intel, McDonalds, Bubba's Bar-B-Que) or their agents (e.g. Lamar, Clear Channel, CBS Outdoor).

The registrar device may use the images 212 (FIG. 2C) downloaded by a remote device to drive traffic to websites associated with observed physical form media. The registrar device may be configured to create a “click through” record for each linking to the digital content using the hyperlinked digital images from the at least one remote device, the “click through” record including an identifier of the remote device and an identifier of the storage devices (see FIG. 3A). The Affiliate ID of the registrar device may be sent to a website associated with a physical form medium represented by a registered image when the prospect (observer) selects 214 (FIG. 2C) by touch or voice a downloaded image 212 (FIG. 2C). The registrar device may be established as an affiliate with each commercial website from which images representing physical form media are registered. Each “dick through” from a registered image to a website may result in an affiliate payment to the owner/operator of the registrar device. The digital content may include at least one of text, images, audio, and video. The remote device may be at least one of a personal mobile communication device and a mobile communication device integrated into a transport vehicle (see FIG. 3A). The remote device may include a camera capable of producing digital images having image file headers that include at least geospatial coordinates [see FIG. 4], and a short-range wireless communications capability such as implemented for Bluetooth and Near Field Communications.

Transmission of a registered digital image to a remote mobile device for a physical form digital display medium may be time synchronized with images displayed periodically on the digital display medium by correlating a display schedule 216 (FIG. 2A) for the digital medium with the time of control activation 209 (FIG. 2C) at the remote mobile device coupled with its geo-spatial coordinates and route vector 210 (FIG. 2C); calculating an approximate point in time that the remote device was located within the pre-determined range of the physical form digital display medium. If the route vector 210 (FIG. 2C) value is essentially zero and the remote mobile device is within the pre-determined range, the digital image transmitted 216 (FIG. 2A) from the registrar device for the physical form digital display medium will correspond to the image being displayed on the medium at the time the control on the remote device was activated 209 (FIG. 2C); both the physical form digital medium and the remote device referencing Greenwich Mean Time (GMT). If the route vector 210 (FIG. 2C) value is moot zero, an alternative to transmitting 216 (FIG. 2A) a single image from the registrar device is to transmit to the remote device all of the images scheduled for display on the physical form digital medium during the time frame that the remote mobile device was within the pre-determined range. The pre-determined range may be established by the provided instruction set 206 (FIG. 2B) as a fixed or adjustable range, and may correspond to variable parameters of the route vector.

A displayed digital image representing a physical form medium may have a plurality of digital images associated with it. Selecting the displayed image initiates transmission of the related images to the remote mobile device from the registrar device. The each digital image in the plurality of registered digital images related to the digital image representing the image displayed on the physical form medium includes a Uniform Resource Locator. The plurality of associated digital images may be displayed 212 (FIG. 2C) in a scrollable array, “picture box” or slideshow. Selecting 214 (FIG. 2C) by touch or voice command an image displayed on the remote device activates a hyperlink in the selected image, connecting 215 (FIG. 2C) the remote device to a social network, web site, or network storage [see FIG. 1] using the Uniform Resource Locator to access digital content relevant to the content of the physical form medium depicted in the selected image. A voice command 214 (FIG. 2C) may recite a name or number which may be visible on a depicted image, initiating access to stored digital content using the Uniform Resource Locator hyperlinked in the digital images.

Referring now to FIG. 3A, a diagram is shown depicting a non-limiting configuration of the registrar device 300. The registrar device 300 is connectable to a communication network 301 accessible to at least one personal mobile device 302 or integrated mobile device 303, and at least one registrant 304 which may include a database containing physical media registration data [see FIG. 1B]. The registrar device 300 includes an access control 305 for controlling electronic access to the registrar device 300, and may incorporate a fee processor for collecting registration fees [see FIG. 1A]. The registrar device 300 includes an operating control 306 for controlling registration and delivery of images of physical form media, and a storage 307 for retaining digital files 308.

Refering to FIG. 3B, the storage 307 is configured to receive at least one digital image representing an image displayed on a physical form medium, geospatial coordinates for the medium, directional (viewing) orientation of the medium, and a Uniform Resource Locator linking the digital image to related digital content. A sound bite in the form of a brief audio message related to the content of the digital image may be stored on the registrar device 300 and transmitted with an associated digital image. The sound bite may be played on a remote device 311 (FIG. 3A) when an image is selected. A text message may also be stored on the registrar device 300 and transmitted with an associated digital image. When a remote device 311 (FIG. 3A) has text-to-speech capability or is paired with a communication system integrated 303 (FIG. 3A) in an automotive vehicle that provides text-to-speech capability such as that enabled by SYNC, the text message associated with the digital message may be converted to an audio message format.

Referring to FIG. 3A digital content associated with physical form media need not be stored on the registrar device 300, and may be stored on social media networks 309, web sites 310, and network storage devices 311 remote from the registrar device 300. The related digital content is accessible over the communication network 301 by at least one remote mobile device 311, when that remote mobile device is physically located in the vicinity of the physical form medium within a predetermined range. The at least one remote mobile 311 device is configured with at least a GPS receiver, a storage for retaining digital files, a display, and a control that when actuated transmits current geospatial coordinates for said remote mobile device 311 to the registrar device 300 (see FIG. 4). The at least one remote mobile device 311 may also include a camera, and a short-range wireless communications capability such as implemented for Bluetooth and Near Field Communications.

The registrar device 300 receives the coordinates or optionally the IBI number and transmits to the remote mobile device 302/303 at least one digital image and Uniform Resource Locator. The stored digital content is accessible to the remote mobile device 311 using the Uniform Resource Locator hyperlinked to the image. A plurality of digital images with hyperlinked Uniform Resource Locators may be transmitted to the remote mobile device 302/303 and presented as a scrollable array, “picture box” or slideshow (see FIG. 5) with endpoint digital images corresponding to physical for media located at endpoints of the predetermined range. The most centered position in the scrollable array, “picture box” or slideshow may be occupied by a digital image corresponding to a physical form medium located within the predetermined range and having geospatial coordinates nearest to the geospatial coordinates for the remote mobile device 311.

The plurality of digital images presented in the scrollable array, “picture box” or slideshow (see FIG. 5) are hyperlinked to stored digital content located on a plurality of storage devices 309/320/311 accessible over the communication network 301, and an affiliate identifier for said registrar device may be included [see FIG. 2A, 216] with the hyperlinked Uniform Resource Locator.

At least one digital image representing a physical form medium, the geospatial coordinates for the medium, the directional (viewing) orientation of the medium, the IBI number, and the Uniform Resource Locator linking the image to stored digital content are transmitted subject to permission by the access control 305 to the registrar device 300 from at least one database 304 resident on a remote storage device. At least one digital image representing a physical form medium, the geospatial coordinates for the medium, the directional (viewing) orientation of the medium, and the Uniform Resource Locator linking the image to stored digital content may be transmitted subject to permission by the access control 305 to the registrar device 300 from at least one remote mobile device among a plurality of remote mobile devices 302 and 303. The geospatial coordinates for the medium may be included in an image file header for the digital image and the Uniform Resource Locator is a hyperlink in the digital image. The Uniform Resource Locator links the digital image to digital content resident on a social network 309 or publicly accessible website 310 or storage 311. The operating control may create a “click through” record 312 for each linking to the digital content using the hyperlinked digital images from the at least one remote mobile device, the “dick through” record including an identifier of the remote mobile device 302 or 303 and an identifier of the storage devices 309, 320, or 311.

The registrar device may be configured with a media selector-comparator 313 and an associated variable rule set. The registrar device selects using the media selector-comparator 313 at least one medium from the media registered on the registrar device and subsequently compares elements in the “dick through record” 312 with the at least one selected medium. The at least one selected medium is identified with at least one of a special event, condition, or reward, where selection of a specific medium and its relationship with the elements of the “dick through record” 312 and the special event, condition, or reward is governed by the variable rule set.

Referring now to FIG. 4 a diagram is shown depicting a non-limiting configuration of a remote mobile device 40. The remote mobile device 40 is configured with at least a GPS receiver 41, a storage 42 for retaining digital files, a display 43, and a visible control 44 that when actuated transmits current geospatial coordinates for the remote mobile device 40 to the registrar device [see FIG. 3A]. The control 44 may be activated by touch or by voice command [see FIG. 2C, 209]. The registrar device receives the geospatial coordinates and transmits to the remote mobile device 40 at least one digital image and Uniform Resource Locator. An affiliate identifier for the registrar device may be included with a hyperlinked Uniform Resource Locator [see FIG. 2C, 214]. The stored digital content is accessible to the remote mobile device 40 using the Uniform Resource Locator hyperlinked to the digital image. The remote mobile device 40 may be at least one of a personal mobile communication device and a mobile communication device integrated into a transport vehicle (see FIG. 3A). The remote mobile device may include a camera 45 capable of producing digital images having image file headers that include at least geospatial coordinates. The remote mobile device may also include a short-range wireless communications capability 46 such as implemented for Bluetooth and Near Field Communications (NFC).

Referring now to FIG. 5, a diagram is shown depicting a non-limiting scrollable picture array 50 displayed on a remote mobile device 51 with images of physical form media oriented to scroll vertically when the longer dimension of the remote mobile device 51 is oriented vertically, and to scroll horizontally when the longer dimension of the remote mobile device 52 is oriented horizontally. The scrollable picture array 50 is configured with endpoint digital images 1 and 5 corresponding to physical form media located at endpoints of a predetermined range. The positioning of each image of the plurality of digital images in the scrollable picture array 50 may be ordered by the relative distance between the geospatial coordinates of the remote mobile device and the geospatial coordinates of each physical form medium corresponding to each digital image [see FIG. 1B]. The positioning arrangement of images in the scrollable picture array 50 relative to each other may vary, corresponding to the relative distance between the remote mobile device and the physical form media. The most centered position in the array may be occupied by a digital image 4 corresponding to an image displayed on a physical form medium located within the predetermined range and having geospatial coordinates nearest to the geospatial coordinates for the remote mobile device 51. The most centered position presented in the scrollable picture array 50 shifts to another digital image as the remote mobile device 51 relocates to geospatial coordinates closer to a different physical form medium.

The instruction set (see FIG. 2B, 206) provided to the remote devices may configure each of the remote mobile devices 51 to generate a route vector indicating a direction of motion of each of the remote mobile devices and transmitting the route vector to the registrar device [see FIG. 2C, 210]. The digital images may be added to the scrollable picture array 50 representing physical form media located and having a viewable orientation within the predetermined range in the direction of motion of the remote mobile device 51, and digital images may be deleted from the scrollable array 50 when the geospatial coordinates of their corresponding physical form media are no longer within the predetermined range. The digital images within any instant predetermined range can be saved on command, either touch or verbal, in the storage of the remote device. The instruction set may enable autopanning or perpetual panning. Autopanning is initiated by a touching and dragging motion on an image in the scrollable picture array 50 and the displayed images move in the direction of the dragging motion left or right, or up or down, depending on the orientation of the remote mobile device 51 and the number of images in the array. Perpetual panning scrolls the displayed images in the scrollable picture array 50 continuously [essentially in a loop or a sequential stream] at a predetermined rate which may be adjusted by the user. Alternatively, the instruction set may configure the remote mobile device to display digital images in a “picture box” or slideshow, each alternative presenting images in a manner similar to the scrollable picture array, and each display controlled in a similar manner.

The instruction set (FIG. 2B, 206) may configure at least one remote mobile device 51 with an image table 53 for accepting from the registrar device at least one name or number correlated with at least one registered digital image representing a physical form medium, and a Uniform Resource Locator for linking to a social network site, web site, or network storage site [see FIG. 3A] having digital content related to the image presented on the physical form medium, the digital content being accessible to the remote mobile device 51 on storage servers at the sites connected to the communications network [see FIG. 3A]. A remote device having requisite verbal recitation capability may be configured to recite on command or automatically on receipt at least one name, phrase, or number correlated with at least one registered digital image representing a physical form medium, the at least one name, phrase, or number having been received from the registrar device and stored in the image table 53.

In the non-limiting example shown in FIG. 5, the content (e.g., content1 and content2) related to a listed digital image title (e.g. Digital Image 1 and Digital Image 2) is included in the Uniform Resource Locator enabling direct access at the web site (e.g., www.website1 and www.website2) to the content by selecting a listed image. Recitation by the user in a verbal command the at least one name, phrase, or number accepted into in the image table 53 activates, using the Uniform Resource Locator, connection of the remote mobile device 51 to the site having the digital content related to the image presented on the physical form medium [see FIG. 2C & FIG. 3A]. A plurality of names and Uniform Resource Locators may be accepted into the image table 53, each name correlated with a digital image of a physical form medium and each associated Uniform Resource Locator corresponding to the network address of the site having digital content related to the image presented on the physical form medium and represented by the digital image. The digital content returned may be varied as a function of time of day or other factors considered relevant to the effectiveness of the content to be provided. Factors such as the region of the country in which the physical form medium is located and identifiers related to the specific user of a mobile device may be considerations in determining the digital content delivered.

The stored digital content in the form of text, images, audio, and video may be accessed by the remote mobile devices 51 using the Uniform Resource Locators hyperlinked to the digital images or included in an image table 53, when the remote mobile devices 51 are physically located in the vicinity of the media within a predetermined range. Activation of the hyperlink in an image may be initiated by touching a displayed digital image or when a remote mobile device 51 is configured with voice recognition, reciting a voice command [see FIG. 2C, 214]. A voice command may include a name or phrase related to the digital image or a number visible on the digital image. The most centered position presented in the scrollable picture array 50 shifts to another digital image as the remote mobile device 51 relocates to geospatial coordinates closer to a different physical form medium. An image table 53 is updated in a corresponding way. Each remote mobile device 51 is configured with at least a GPS receiver, a storage for retaining digital files, a display, and a control that when actuated transmits current geospatial coordinates for the remote mobile device 51 is the registrar device [see FIG. 2C, 210]. The control may be a visible named icon displayed on the remote mobile device [see FIG. 4]. The control may be activated by touch or by voice command [see FIG. 2C, 209]. A remote mobile device 51 may be a personal mobile communication device or a mobile communication device integrated into a transport vehicle such as an automobile [see FIG. 3A]. A camera may also be included in a configured remote mobile device [e.g., personal mobile communication devices], the camera being capable of producing digital images having image file headers that include at least geospatial coordinates [see FIG. 4].

In the non-limiting example shown in FIG. 5, a remote mobile device of the present invention may comprise a communication device 611 integrated into a transport vehicle 610 such as an automobile, provided the integrated communication device 611 has been configured with the instruction set (FIG. 2B, 208). The integrated communication device 611 may share via a wireless link such as a Bluetooth connection 612 after pairing the devices at least a part of the feature set of the personal mobile device 40 of the present invention, including but not limited to activation control (FIG. 2C, 209) display, transmission, and voice recognition. Position and transit direction information, as well as time of day, may be accumulated by a dedicated or shared GPS receiver comprising a feature of either the mobile device 40 or the integrated device 611. Alternatively, at least position and transit direction information may be accessed from a vehicle event data recorder 614 such as prescribed in Section 31406 of U.S. Senate Bill 1813 enacted in the 112^{th} Congress, 2012. Authenticating information for the user and vehicle, as well as time of day, may also be accessed from the vehicle event data recorder 614. Position, transit, time of day, and authentication information may be transmitted to the registrar device [FIG. 3A, 300]. Registered digital images may be returned to the personal mobile device 40 or the integrated communication device 611 and displayed. Selection of a specific displayed image including by touch or reciting a name or number activates the URL link to a related landing page on at least one of a web site or storage device accessible over the Internet and returns relevant digital content. The digital content may be returned to and displayed by the integrated communication device 611. The digital content will correspond to at least the information accessed from the vehicle event data recorder 614 or the dedicated or shared GPS receiver. The digital content returned may be a function of time of day or other factors considered relevant to the effectiveness of the content to be provided. Factors such as the region of the country in which the physical form medium is located and identifiers related to the specific user of a mobile device may be considerations in determining the digital content to be delivered

In the present invention virtual form information is accessed based on what an observer sees around their present location in the form of registered images as opposed to submission of a textual query to a knowledge acquisition system (e.g., search engine) or selecting an icon or picture on a displayed digital map such as in Google Maps. The present invention can directly answer the question “what am I seeing around me now?” or “tell me about what I see” by checking for registered images in a surrounding range and, when present and downloaded, selecting displayed image depictions of observable image scenes at a particular geo-spatial location.

Another aspect of the present invention is that geotagged image scenes are registered at a registrar device, but the geotagged image scenes and related digital content are not necessarily stored at the registrar device. Only reduced form images (e.g., lower resolution, thumbnail images) hyperlinked to associated social media or other websites need to be stored and associated with the geospatial coordinates of the location where the digital image scene was captured or the physical form media is displayed. The digital images may be uploaded to an associated social media network, website or publically accessible storage device. Storing only the reduced form (e.g., lower resolution, thumbnail) image and not the related digital content has the benefit of significantly reducing the amount of storage capacity required to scale the registrar device to support a multitude of registrants. This shifts responsibility and cost for maintaining digital content storage and information access control capacity to image registrants. Linking reduced form (e.g., low resolution, thumbnail) images to landing pages on social media networks or other websites enables control of associated content by the “owner” of the image scene or physical form media on a third party site. The owner controls specifically the content that an observer of physical form media receives related to the images displayed on the media. There are not the thousands of “hits” that may be displayed when using a search engine to search for the same content. The linkage between displayed physical form media and the related digital content is specific and direct. Storage of digital content related to registered image scenes can be shifted to the third party site, dramatically reducing the storage capacity required to scale the registrar device.

Yet another aspect of the present invention is the method of monetizing “click through” to a website content or landing page. Instead of sending an Affiliate ID when a prospect (observer) clicks on an advertisement presented on a web page as is typical, the Affiliate ID of the registrar device may be included and sent with the URL hyperlinked in each registered image. The Affiliate ID of the registrar device may be sent to a website associated with a physical form medium represented by a registered image when the prospect (observer) selects (e.g., touches, recites the name of) a downloaded image. The registrar device can be established as an affiliate with each commercial website from which images representing physical form media are registered. The registrar device can drive traffic to websites associated with physical form media. Each “click through” from a registered image to a website may result in a payment to the owner/operator of the registrar device. The “click-through” record also includes an identifier of the mobile device, which can be provided to the registrant related to each “click-through” action. The “click-through” information can be used to assess the effectiveness of physical media messages in generating user expressions of interest as opposed to simple impressions estimated from potential observer traffic.

The present invention provides for dynamically and directly associating physical form information observed from various perspectives in a particular place (e.g., a landmark) or presented on a physical medium (e.g., a billboard or building exterior) in a particular location to information stored remotely in a virtual medium (e.g., social network, website, or other networked storage device), and enabling “single touch” or “single command” access to the virtual (digital) form information associated with the observed physical form information when an observer encounters physical form information of interest. The present invention provides a method and apparatus for directly communicating digital content to a public that is not actively searching for a particular business, product, event, or service.

A non-limiting example of the use of the present invention is to obtain from a website, without searching with a search engine, rich content related to an image displayed on a billboard. While riding in an automobile a user observes an image of interest displayed on a billboard. The user activates the visible control on a personal mobile communication device or communication device integrated into an automotive vehicle that has the instruction set enabled. The communication device connects to the registrar device over the communication pathway and transmits its geospatial coordinates (its physical location) to the registrar device. The registrar device receives the geospatial coordinates of the communication device and determines which registered digital images are located within a predetermined range of the received geospatial coordinates. The registrar device returns to the communication device the registered digital images corresponding to the images displayed on all observable physical form media within the predetermined range. The returned images are displayed on the communication device in a scrollable presentation (array, “picture box”, slideshow). The user of the communication device may select by touch or voice command, depending upon how the device is configured, the digital image of interest, after scrolling the image display if needed. If desired the user may save the digital images within any instant predetermined range on command, either touch or verbal, in the storage of the remote device. Selecting the digital image of interest initiates connection over a communication pathway to a third party site (social media, a web site, or networked storage device) using the Uniform Resource Locator hyperlinked in the selected digital image. The communication device receives related digital content from the third party site.

Another non-limiting example of the use of the present invention is to obtain from a website, without searching with a search engine, rich content related to displayed graffiti on a sidewalk. A student on a college campus creates a graffiti display (e.g., using chalk) on a sidewalk announcing a fund raising event. The student, having a mobile device enabled with the present invention, photographs the graffiti display using the mobile device (e.g., smart phone) creating a digital image including geospatial coordinates and an image name (e.g. “10K Run”). The student accesses the student's account on the registrar device, and uploads and registers the digital image and associated Uniform Resource Locator for a “Facebook” Wall page (i.e., social media) that includes details for the event. Subsequently, while walking on the college campus, a user of a mobile device enabled with the present invention observes graffiti of interest displayed on the sidewalk (i.e., the graffiti created by the student). The user activates the visible control on the mobile device that has the instruction set enabled. The mobile device connects to the registrar device over the communication pathway and transmits its geospatial coordinates (its physical location) to the registrar device. The registrar device receives the geospatial coordinates of the mobile device and determines which registered digital images are located within a predetermined range of the received geospatial coordinates. The registrar device returns to the mobile device the registered digital images corresponding to the images displayed on all observable physical form media including the graffiti display on the sidewalk within the predetermined range. The returned images are displayed on the device in a scrollable presentation (array, “picture box”, or slideshow). The user is stationary while observing the graffiti display and activating the control on the mobile device, and as a result the range vector has a zero value and the digital image of the graffiti display is centered in a scrollable picture array presented on the mobile device. The user of the mobile device may select by touch or voice command, depending upon how the mobile device is configured, the digital image of interest (the graffiti) Selecting the digital image of interest initiates a connection over a communication pathway to the student's Facebook Wall page, using the Uniform Resource Locator hyperlinked in the selected digital image. The mobile device receives related digital content from the student's Facebook Wall page.

Another non-limiting example of the use of the present invention is to provide to an observer a plurality of digital images related to the image of interest displayed on a physical form medium, each image in the plurality of digital images including a Uniform Resource Locator and an identifier of the physical form medium to which it is related. A “core” physical image can be presented on the physical medium to catch an observer's attention. An example would be a Ford Motor company theme billboard for a new model year. Activating the visible control on the mobile device results in download and presentation of all registered digital images within the predetermined range, including the digital image representing the core physical image displayed on the billboard. Selecting the core digital image of interest results in download and presentation of the plurality of digital images (e.g., in “billboard format”) with varying but related messages. “Billboard format” images for all or part of the new Ford models can be presented when the core image was selected. Each of the “billboard format” images are linked by a Uniform Resource Locator to specific relevant content. Touching or reciting the name of an image for a particular model will link to web content for that model. Providing a plurality of digital images related to a core physical image as described in this non-limiting example achieves some of the benefits of digital physical form media capable of displaying multiple physical form billboard images and at lower cost.

Another non-limiting example of the use of the present invention is to provide a mechanism for creating physical form media. Because consumer expressions of interest trump simple impressions resulting from passing exposure to an advertising message, the present invention provides a registrar device that includes a media selector-comparator for selecting at least one medium from the media registered on the registrar device and for subsequently comparing elements in a “click through record” with the at least one selected medium. The at least one selected medium is identified with at least one of a special event, condition, or reward. A special event could comprise a chance to win money or other prizes. A condition may include discounts on products and services or amassing points that can be renewed for products and services. Direct rewards could be in the form of monetary prizes paid when a “click through” occurs as a result of observing a specific physical form medium. Evidence of winning or qualifying can be returned directly to a mobile device on the occurrence of a “click through” from a specific observed medium. In the present invention, selection of a specific medium and its relationship with the elements of the “click through record” and the special event, condition, or reward is governed by a variable rule set. This enables an advertiser to create custom media events involving incentive programs that foster consumer response driven from physical form media and targeted to specific content rich messages, where a consumer response may range from a single “click through” expression of interest to a product purchase. Media events may include promotions such as a “billboard lottery” or “treasure hunt” where specific physical form media are randomly selected and designated as the “target find” for winning. Physical media may be made part of “geocaching” treasure hunt games, where players try to find hidden caches using GPS-enabled devices. Media events may also include discount “coupons” or product “vouchers” downloaded directly to a mobile device.

Another non-limiting example of the use of the present invention is to provide to an observer a plurality of digital images comprising “virtual billboards” related to a particular place or an image of interest displayed on a physical form medium, each virtual billboard in the plurality of digital images including a Uniform Resource Locator and an identifier of the place or physical form medium to which it is related.

A “core” physical mage may be presented on the physical medium to catch an observer's attention or there may be a specific determination by the instruction set operable in the mobile device that it is positioned within a predetermined range of a particular place (e.g., NASCAR International Raceway, Daytona Beach, Fla.) for which there are registered virtual billboards. The instruction set of the present invention operating on the mobile device may be configured by the user to continuously present a “stream” of registered physical and/or virtual billboards related to the geospatial location of the mobile device. With reference to the physical media (roadside billboard) advertising the City of Branson, Mo. mentioned under Background of the Invention, activation of the visible control on the mobile device either in a manual or automatic mode when the mobile device is in a predetermined range of the physical media advertising Branson or a physical exit (or signs indicating exits) from an Interstate or other highway results in image download from the registrar device and presentation on the mobile device of all registered virtual billboards for Branson, Mo. Among the registered virtual billboards may be included the digital image representing the image displayed on the Branson billboard. Presentation of the virtual billboards in a scrollable array, picture box or slide show can be ordered in a sequence recorded on the registrar device and determined by a bidding process, wherein the centered position in the array goes to the highest bidder. Subsequent positioning away from the centered position may be determined by the succession of lower bids as they get progressively lower. The virtual billboards presented may be in “billboard format” with varying messages for businesses, products, places, and events related to or available in a location such as Branson, Mo. Each of the virtual billboard images are linked by a Uniform Resource Locator to specific relevant digital content located on a web site, social media, or other publically accessible network storage. Touching a virtual billboard image or reciting a verbal command such as a name, phrase or number visible on the virtual billboard image will link to digital content for that virtual billboard. A “click through” charge may also be recorded by the registrar device and by a destination web site holding the related digital content. Providing a plurality of virtual billboards related to a core physical mage or a specific place as described in this non-limiting example achieves many of the benefits of presenting roadside physical form media or digital physical form media capable of displaying multiple physical form billboard images, and does so at lower cost. This aspect of the present invention also provides a cost-effective way for advertisers located more remotely from a major highway or relatively populated pedestrian route to get their message presented to observers that are not actively seeking information about their offering. This aspect of the present invention can answer the question “what is going on around me in terms of businesses, events, and product offerings” without the observer actively searching for the information.

Those skilled in the art will appreciate that in some embodiments of the invention, the functional modules of the registrar device as well as the personal and the integrated communication devices may be implemented as pre-programmed hardware or firmware elements (e.g., application specific integrated circuits (ASICs), electrically erasable programmable read-only memories (EEPROMs), etc.), or other related components. Mobile communications devices that can use the present invention may include but are not limited to any of the “smart” phones or tablet computers equipped with digital displays, wireless communication connection capabilities such as iPhones and iPads available from Apple, Inc., as well as communication devices configured with the Android operating system available from Google, Inc. In addition, it is anticipated the new communication devices and operating systems will become available as more capable replacements of the forgoing listed communication devices, and these may use the present invention as well.

In other embodiments, the functional modules of the registrar device may be implemented by an arithmetic and logic unit (ALU) having access to a code memory which holds program instructions for the operation of the ALU. The program instructions could be stored on a medium which is fixed, tangible and readable directly by the processor, (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The program instructions stored in the code memory can be compiled from a high level program written in a number of programming languages for use with many computer architectures or operating systems. For example, the high level program may be written in assembly language such as that suitable for use with a pixel shader, while other versions may be written in a procedural programming language (e.g., “C”) or an object oriented programming language (e.g., “C++” or “JAVA”).

Those skilled in the art will also appreciate that in some embodiments of the invention, the functional modules of the personal and the integrated mobile communication devices such as a scrollable picture array, “picture box” or slideshow may be implemented by a number of methods and using a variety of development tools. A non-limiting method for implementing a scrollable picture array is presented in APPENDIX 1. A non-limiting method for implementing a scrollable “picture box” is presented in APPENDIX 2. A non-limiting example of a development tool for presenting a slideshow is the Simple Controls Gallery product available from Dynamic Drive.

In other embodiments, the registrar device may be a web hosted machine or a virtual machine. A Web host can have anywhere from one to several thousand computers (machines) that run Web hosting software, such as Apache, OS X Server, or Windows Server. A virtual machine (VM) is an environment, usually a program or operating system, which does not physically exist but is created within another environment (e.g., Java runtime). In this context, a VM is called a “guest” while the environment it runs within is called a “host.” Virtual machines are often created to execute an instruction set different than that of the host environment. One host environment can often run multiple VMs at once.

While specific embodiments of the present invention have been described and illustrated, it will be apparent to those skilled in the art that numerous modifications and variations can be made without departing from the scope of the invention as defined in the appended claims. It is understood that the words that have been used are words of description and illustration, rather than words of limitation. Although the invention has been described with reference to particular means, materials and embodiments, the invention is not intended to be limited to the particulars disclosed; rather, the invention extends to all functionally equivalent structures, methods and uses, such as are within the scope of the appended claims.

I claim:

1. A computer-readable media tangibly embodying a program of instructions executable by a registrar device to implement a method, the registrar device being capable of interfacing with a communications network adapted to provide registered images of physical form media to a plurality of mobile communication devices connectable to the communication network, the method comprising: registering on a registrar device digital images of physical form media, receiving at said registrar device geospatial coordinates of said mobile communication devices, transmitting to said mobile communication devices from said registrar device registered digital images of physical form media observable at the received geospatial coordinates, including hyperlinks in registered digital images enabling access to digital content related to physical form media, said digital content being accessible to said mobile communication devices on at least one of a social network, publicly accessible website, and network storage device.

2. A registrar device connectable to a communication network accessible to at least one remote device, the registrar device comprising:
a user access control for controlling electronic access to said registrar device;
an operating instruction set for controlling registration and delivery of images representing physical form media;
an electronic storage for retaining digital files, said storage configured to receive at least one digital image representing a physical form medium, geospatial coordinates for said medium, directional (viewing) orientation of the medium, and a universal resource locator linking said image to digital content, said digital content accessible over said communication network by the at least one remote device, when said at least one remote device is physically located in the vicinity of said medium within a predetermined range;
wherein said at least one remote device is configured with at least a GPS receiver, an electronic storage for retaining digital files, a visual display, and a communication control that when actuated transmits current geospatial coordinates for said at least one remote device to said registrar device;
wherein said registrar device receives said coordinates and transmits to said at least one remote device said at least one digital image and universal resource locator, and
wherein said stored digital content is accessible to said at least one remote device using said universal resource locator hyperlinked to said image.

3. The registrar device of claim 2, wherein a plurality of digital images with hyperlinked universal resource locators are transmitted from said registrar device to said at least one remote device and presented as a scrollable display, and an affiliate identifier for said registrar device is included with said hyperlinked universal resource locators.

4. The registrar device of claim 3, wherein said operating instruction set creates a click through record for each linking to said digital content using said hyperlinked digital images from said at least one remote device, said click through record including an identifier of said remote device, an identifier of said registrar device, and an identifier of at least one of a social network, publicly accessible website, and network storage device.

5. The registrar device of claim 3, wherein the positioning of each image of said plurality of digital images in said scrollable display is ordered by the relative distance between the geospatial coordinates of said at least one remote device and the geospatial coordinates of each of said physical form medium corresponding to each digital image.

6. The registrar device of claim 5, wherein said at least one remote device generates a route vector indicating a direction of motion of said at least one remote device and transmits said route vector to said registrar device, and wherein digital images are added to said scrollable display representing physical form media located within said predetermined range and viewable in the direction of motion of said at least one remote device and digital images are deleted from said scrollable display when the geospatial coordinates of their corresponding physical form media are no longer within said predetermined range.

7. The registrar device of claim 2, wherein said at least one digital image representing a physical form medium, said geospatial coordinates for said medium, directional (viewing) orientation of the medium, and said universal resource locator linking said image to stored digital content is transmitted subject to permission by said user access control to said registrar device from at least one of a remote device among a plurality of remote devices and a database resident on a remote storage device.

8. The registrar device of claim 7, wherein said geospatial coordinates for said medium are included in an image file header for said digital image and said universal resource locator is a hyperlink in said digital image.

9. The registrar device of claim 8, wherein said universal resource locator links said digital image to digital content resident on at least one of a social network, publicly accessible website, and a network storage device.

10. A method of accessing over a communication network digital content stored on a storage device and adjoined to digital images representing physical form media, the method comprising:
providing a registrar device connectable to said communication network and accessible to a plurality of remote devices, said registrar device including a user access control for controlling electronic access to said registrar device, an operating instruction set for controlling registration and delivery of images of physical form media, and an electronic storage for retaining digital files;
providing an application instruction set for configuring said plurality of remote devices to enable communication with said registrar device and presentation of said digital images;
receiving at said registrar device at least one digital image representing a physical form medium, geospatial coordinates for said medium, directional (viewing) orientation of the medium, and a universal resource locator for linking said image to stored digital content accessible over said communication network;
receiving at said registrar device current geospatial coordinates from at least one remote device of said plurality of remote devices;
transmitting to said at least one remote device said at least one digital image representing said physical form medium and said universal resource locator.

11. The method of claim 10, wherein a plurality of digital images with hyperlinked universal resource locators are transmitted to said at least one remote device and presentable as a scrollable display, and an affiliate identifier for said registrar device is included with said hyperlinked universal resource locators.

12. The method of claim 11, wherein the positioning of each image of said plurality of digital images in said scrollable display is ordered by the relative distance between the geospatial coordinates of said remote device and the geospatial coordinates of each of said physical form medium corresponding to each digital image.

13. The method of claim 12, wherein a route vector is generated for said at least one remote device indicating a direction of motion of said at least one remote device and said route vector is received by said registrar device, and wherein digital images are added to said scrollable display representing physical form media located within said predetermined range and viewable in the direction of motion of said at least one remote device and digital images are deleted from said scrollable display when the geospatial coordinates of their corresponding physical form media are no longer within said predetermined range.

14. The method of claim 10, wherein said at least one digital image representing a physical form medium, said geospatial coordinates for said medium, directional (viewing) orientation of the medium, and said universal resource locator linking said image to stored digital content is receivable subject to permission by said user access control from at least one of a remote device among a plurality of remote devices and a database resident on a remote storage device.

15. The method of claim 10, wherein said geospatial coordinates for said medium are included in an image file header for said digital image and said universal resource locator is a hyperlink in said digital image.

16. The method of claim 15, wherein said universal resource locator links said digital image to digital content resident on at least one of a social network, publicly accessible website, and network storage device.

17. The method of claim 16, wherein said operating instruction set creates a click through record for each linking to said digital content using said hyperlinked digital images from said at least one remote device, said click through record including an identifier of said at least one remote device, an identifier of said registrar device, and an identifier of at least one of a social network, publicly accessible website, and network storage device.

18. The method of claim 10, wherein said at least one remote device is further configured with an image table for accepting from said registrar device at least one name, phrase or number correlated with at least one registered digital image representing a physical form medium, and a universal resource locator for a social network site, web site, or network storage site having digital content related to an image presented on said physical form medium, said digital content comprising at least one of text, graphics, audio, and video being accessible to said at least one remote device at said sites connected to the communications network, and wherein on reciting in a verbal command said at least one name, phrase, or number activates, using the universal resource locator, connection of the remote device to the site having digital content related to said image presented on said physical form medium.

19. The method of claim 10, wherein a plurality of digital images with hyperlinked universal resource locators are transmitted to said remote device and presented as a scrollable display with endpoint digital images in said display corresponding to physical form media located at endpoints of said predetermined range and a most centered position in said display occupied by a digital image corresponding to a physical form medium located within said predetermined range and having geospatial coordinates nearest to said geospatial coordinates for said remote device, wherein said scrollable display is one of a picture array, a picture box, and a slideshow.

20. The method of claim 19, wherein said most centered position presented in said scrollable display shifts to another digital image as said remote device relocates to geospatial coordinates nearer a different physical form medium.
